(19) United States
(12) Patent Application Publication
(10) Pub. No.: US 2025/0376194 A1
(43) Pub. Date: Dec. 11, 2025

(54) INFORMATION PROCESSING METHOD, AND INFORMATION PROCESSING SYSTEM

(71) Applicant: Panasonic Intellectual Property Management Co., Ltd., Osaka (JP)

(72) Inventors: Motoshi ANABUKI, Hyogo (JP); Takahiro YONEDA, Osaka (JP); Shunsuke KUHARA, Osaka (JP); Yuki MATSUMURA, Kyoto (JP)

(21) Appl. No.: 19/313,029

(22) Filed: Aug. 28, 2025

Related U.S. Application Data
(63) Continuation of application No. 17/724,057, filed on Apr. 19, 2022.
Application No. 17/724,057 is a continuation of application No. PCT/JP2021/001891, filed on Jan. 20, 2021.

(30) Foreign Application Priority Data
Jan. 28, 2020 (JP) 2020-011407

(51) Int. Cl. B60W 60/00; B60W 50/14

(52) U.S. Cl. CPC B60W 60/0053; B60W 50/14; B60W 2556/45

(57) ABSTRACT

An information processing method to be executed by a computer includes: obtaining a departure place and a destination; obtaining driving information concerning driving of a moving body by a passenger or a remote worker, the moving body being switchable between autonomous driving and manual driving; calculating a travel route according to the departure place, the destination, and the driving information, the travel route being at least one of a first route including a manual zone where the passenger or the remote worker is requested to drive or a second route not including the manual zone; and outputting the travel route calculated.

### CROSS REFERENCE TO RELATED APPLICATIONS

This is a continuation application of U.S. patent application Ser. No. 17/724,057, filed on Apr. 19, 2022, which is a continuation application of PCT International Application No. PCT/JP2021/001891 filed on Jan. 20, 2021, designating the United States of America, which is based on and claims priority of Japanese Patent Application No. 2020-011407 filed on Jan. 28, 2020. The entire disclosures of the above-identified applications, including the specifications, drawings and claims are incorporated herein by reference in their entirety.

### FIELD

The present disclosure relates to an information processing method and an information processing system for a moving body switchable between autonomous driving and manual driving.

### BACKGROUND

Recently, a variety of examinations have been made in autonomous vehicles switchable between autonomous driving and manual driving. For example, PTL 1 discloses an information processing apparatus which presents a manual driving zone and an autonomous driving zone in a driving route.

### CITATION LIST

### Patent Literature

PTL 1: WO 2019/082774

### SUMMARY

### Technical Problem

However, the information processing apparatus disclosed in PTL 1 does not suggest a driving route satisfying the needs for manual driving of a moving body such as an autonomous vehicle in some cases. For example, according to PTL 1, there may occur cases where any passenger cannot drive when the passengers in the autonomous vehicle are notified of the manual driving zone.

Thus, an object of the present disclosure is to provide an information processing method and an information processing apparatus which can output a driving route corresponding to needs for manual driving of a moving body.

### Solution to Problem

The information processing method according to one aspect of the present disclosure is an information processing method to be executed by a computer, the information processing method including: obtaining a departure place and a destination; obtaining driving information concerning driving of a moving body by a passenger or a remote worker, the moving body being switchable between autonomous driving and manual driving; calculating a travel route according to the departure place, the destination, and the driving information, the travel route being at least one of a first route including a manual zone where the passenger or the remote worker is requested to drive or a second route not including the manual zone; and outputting the travel route calculated.

The information processing system according to one aspect of the present disclosure is an information processing system, including: a first obtainer which obtains a departure place and a destination; a second obtainer which obtains driving information concerning driving of a moving body by a passenger or a remote worker, the moving body being switchable between autonomous driving and manual driving; a calculator which calculates a travel route according to the departure place, the destination, and the driving information, the travel route being at least one of a first route including a manual zone where the passenger or the remote worker is requested to drive or a second route not including the manual zone; and an outputter which outputs the travel route calculated.

### Advantageous Effects

The information processing method according to one aspect of the present disclosure can output a driving route corresponding to needs for manual driving of a moving body.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the functional configuration of the information processing system according to Embodiment 1.

FIG. 2 is a table showing one example of the result of input by the passenger according to Embodiment 1.

FIG. 3 is a table showing one example of the route information according to Embodiment 1.

FIG. 4 is a flowchart illustrating the operation before driving of the vehicle in the information processing system according to Embodiment 1.

FIG. 5 is a flowchart illustrating one example of the operation to search for the candidate route illustrated in FIG. 4.

FIG. 6 is a table showing one example of the result of route search according to Embodiment 1.

FIG. 7 is a flowchart illustrating one example of the operation to extract the candidate route illustrated in FIG. 5.

FIG. 8 is a table showing one example of the candidate route according to Embodiment 1.

FIG. 9 is a flowchart illustrating the operation to determine whether the manual intervention by the driver is appropriate in the information processing system according to Embodiment 1.

FIG. 10 is a flowchart illustrating the operation to reset the driving route in the information processing system according to Embodiment 1.

FIG. 11 is a flowchart illustrating one example of the operation to update the route information illustrated in FIG. 10.

FIG. 12 is one example of a table according to Embodiment 1 in which the road condition is associated with the manual intervention needed therefor.

FIG. 13 is a flowchart illustrating one example of the operation to reset the driving route illustrated in FIG. 10.

FIG. 14 is a table showing one example of the result of input by the passenger according to Modification 1 of Embodiment 1.

FIG. 15 is a table showing one example of the route information according to Modification 1 of Embodiment 1.

FIG. 16 is a table showing one example of the result of route search according to Modification 1 of Embodiment 1.

FIG. 17 is a flowchart illustrating one example of the operation to extract the candidate route according to Modification 1 of Embodiment 1.

FIG. 18 is a table showing one example of the candidate route according to Modification 1 of Embodiment 1.

FIG. 19 is a table showing one example of the result of input by the passenger according to Modification 2 of Embodiment 1.

FIG. 20 is a table showing one example of the route information according to Modification 2 of Embodiment 1.

FIG. 21 is a flowchart illustrating one example of the operation to extract the candidate route according to Modification 2 of Embodiment 1.

FIG. 22 is a table showing one example of the candidate route according to Modification 2 of Embodiment 1.

FIG. 23 is a diagram illustrating a schematic configuration of the information processing system according to Embodiment 2.

FIG. 24 is a flowchart illustrating the operation to reset a degree of monitoring priority in the information processing system according to Embodiment 2.

### DESCRIPTION OF EMBODIMENTS

The information processing method according to one aspect of the present disclosure is an information processing method to be executed by a computer, the information processing method including: obtaining a departure place and a destination; obtaining driving information concerning driving of a moving body by a passenger or a remote worker, the moving body being switchable between autonomous driving and manual driving; calculating a travel route according to the departure place, the destination, and the driving information, the travel route being at least one of a first route including a manual zone where the passenger or the remote worker is requested to drive or a second route not including the manual zone; and outputting the travel route calculated.

Thereby, the travel route is calculated according to the driving information of the passenger or the remote worker, thus enabling output of a route which reflects the needs of the passenger for manual driving.

Moreover, for example, the driving information may include a driving skill indicating whether the passenger or the remote worker can drive the moving body.

Thereby, the travel route is calculated according to the driving skill, and thus reflects the presence/absence of the driver or the remote worker. For example, when the driving skill indicates that the passenger or the remote worker can drive the moving body, that is, when the passengers include a driver or the remote worker can perform remote operation, the first route including the manual zone can be output. Accordingly, the travel route corresponding to the driving skill of the passenger riding the moving body or that of the remote worker can be output.

Moreover, for example, the calculating of the travel route may include calculating only the second route when the driving skill indicates that the passenger or the remote worker cannot drive; and calculating at least one of the first route or the second route when the driving skill indicates that the passenger or the remote worker can drive the moving body.

Thereby, the travel route corresponding to the driving skill, that is, the travel route corresponding to the presence/absence of the driver or the remote worker can be output. For example, when the driving skill indicates that the driver or the remote worker cannot drive the moving body, only the second route not including the manual zone is calculated. Thereby, a travel route which can reach the destination can be calculated even when the driver or the remote worker is absent. Moreover, for example, when the driving skill indicates that the passenger or the remote worker can drive, at least one of the first route or the second route is calculated, increasing alternatives of the travel route compared to the case where only the first route or only the second route is calculated. For example, by calculating the first route, the vehicle can reach the destination even when the vehicle cannot reach the destination only through the autonomous zone. Moreover, for example, by calculating the first route, traveling in the manual zone can reach the destination in a short time even when the vehicle cannot reach the destination only through the autonomous zone without traveling a bypass in some cases. Moreover, for example, even when there is a driver in the moving body or a remote worker assigned to the moving body to perform remote monitoring or remote operation of the moving body, the second route not including the manual zone can be calculated in some cases.

Moreover, for example, the driving information may include a driving content acceptable to the passenger or the remote worker.

Thereby, the travel route is calculated according to the driving content, thus enabling output of the travel route more suitably corresponding to the driving information including the driving needs of the passenger or the remote worker. For example, when a driver is present in the moving body but does not want to drive, the travel route corresponding to the positiveness to driving of the driver can be calculated by calculating the second route. The first route corresponding to the driving content acceptable to the driver can also be calculated.

Moreover, for example, the calculating of the travel route may include: calculating a temporary route according to the departure place and the destination; extracting a manual zone included in the temporary route; determining whether the manual zone extracted is a zone corresponding to the driving content; and calculating the temporary route as the first route when it is determined that the manual zone extracted is the zone corresponding to the driving content.

Thereby, based on whether the manual driving zone corresponds to the driving content included in the driving information, the first route can be calculated among the temporary routes which can reach the destination. In other words, the travel route corresponding to the driving content acceptable to the driver can be calculated as the first route.

Moreover, for example, the driving content may include a driving operation acceptable to the passenger or the remote worker, and the zone corresponding to the driving content may include a zone in which a driving operation requested for travel of the moving body corresponds to the driving operation included in the driving content.

Thereby, the zone corresponding to the driving operation acceptable to the driver or the remote worker is calculated as the first route. In other words, the travel route which the vehicle can travel by performing a manual intervention of the driving operation acceptable to the driver or the remote worker is calculated as the first route. Accordingly, the travel route corresponding to the driving operation executable by the driver or the remote worker can be output.

Moreover, for example, the driving content may include the driving operation acceptable to the passenger or the remote worker, and the zone corresponding to the driving content may include a zone in which a driving operation to improve travel of the moving body corresponds to the driving operation included in the driving content.

Thereby, the zone corresponding to the driving operation which improves travel of the moving body is calculated as the first route. For example, when the driving operation which improves the travel of the moving body is a driving operation which shortens the travel time of the moving body, the first route having a shortened travel time can be calculated.

Moreover, for example, the information processing method may further include obtaining task information of the remote worker; and determining the driving content acceptable to the remote worker, based on the task information.

Thereby, the travel route of the moving body is calculated according to the driving content corresponding to the task conditions of the remote worker. For this reason, the load on the remote worker can be in harmony with the needs of the passenger.

Moreover, for example, the information processing method may further include notifying the passenger or the remote worker who can drive the moving body of a driving request through a presentation apparatus when the moving body reaches the manual zone in the first route output or a place that is a predetermined distance to the manual zone.

Thereby, the driver or the remote worker is notified of the driving request in the manual zone or a place that is the predetermined distance to the manual zone, thus letting the driver or the remote worker know switching to the manual zone. Accordingly, switching from autonomous driving to manual driving can be smoothly performed.

Moreover, for example, the information processing method may further include determining whether the passenger or the remote worker who can drive is driving the moving body in the manual zone in the first route output.

Thereby, it can be determined whether the driver or the remote worker is driving the vehicle when the vehicle is traveling in the manual zone. For example, when the driver or the remote worker is not driving the vehicle while the vehicle is traveling in the manual zone, the travel safety for the moving body can be ensured by stopping the moving body.

Moreover, for example, the driving content may include a driving operation executable by the passenger or the remote worker, the information processing method may further include determining whether the passenger or the remote worker who can drive is driving the moving body in the manual zone in the first route output, and the determining whether the passenger or the remote worker is driving may further include determining whether the driving operation included in the driving content is being performed.

Thereby, it can be determined whether the driver or the remote worker is performing an appropriate driving operation when the vehicle is traveling in the manual zone. In other words, the state of the driving operation by the driver or the remote worker in the manual zone can be obtained.

Moreover, for example, the information processing method may further include outputting an instruction to restrict travel of the moving body when it is determined that the passenger or the remote worker who can drive is not driving the moving body in the manual zone in the first route.

Thereby, the traveling of the moving body is restricted when the driver or the remote worker is not driving the manual zone, thus further ensuring the travel safety for the moving body.

Moreover, for example, the information processing method may further include setting a degree of monitoring priority for the moving body corresponding to the driving information; and outputting the degree of monitoring priority which is set.

Thereby, the driving skill can be used to set the degree of monitoring priority when the travel of the moving body is monitored by the remote worker (operator). The load of monitoring on the operator can be reduced by setting the degree of monitoring priority corresponding to the driving skill. For example, when a higher degree of monitoring priority is set for the driving skill indicating that the driver can drive (namely, when it is considered that manual driving has a higher risk than that of autonomous driving), the operator may intensively monitor the autonomous vehicle in which the driver is present, thus reducing the monitoring load on the operator. When a lower degree of monitoring priority is set for the driving skill indicating that the driver can drive (namely, when it is considered that manual driving has a lower risk than that of autonomous driving), the operator may intensively monitor the autonomous vehicle in which the driver is absent, thus reducing the monitoring load on the operator.

Moreover, for example, the information processing method may further include: obtaining traffic situation information; determining whether a traffic situation in the travel route has changed after the outputting of the travel route, based on the traffic situation information; determining whether the manual zone is added or changed in the travel route due to the change of the traffic situation, when it is determined that the traffic situation has changed; determining whether the passenger or the remote worker can drive the manual zone added or changed according to the driving information, when it is determined that the manual zone is added or changed; and changing the travel route when it is determined that the passenger or the remote worker cannot drive.

Thereby, the travel route can be changed to a travel route which reflects the change when the traffic situation in the travel route has changed and the driver or the remote worker cannot drive the added or changed manual zone. Accordingly, even when the traffic situation has changed, the travel route can be output corresponding to the driving skill of the passenger riding the moving body or that of the remote worker who performs remote monitoring or remote operation of the moving body.

Moreover, for example, the calculating of the travel route may include calculating a plurality of travel routes, and the outputting of the travel route may include presenting the plurality of travel routes as candidate routes through the presentation apparatus.

Thereby, the passenger or the remote worker can select the travel route of the moving body among the candidate routes, thus increasing the freedom of selection of the travel route.

Moreover, for example, an interface for accepting an input of the driving content may be presented through a presentation apparatus.

Thereby, the passenger or the remote worker can input the driving content while checking the interface such as an image.

Moreover, the information processing system according to one aspect of the present disclosure is an information processing system, including: a first obtainer which obtains a departure place and a destination; a second obtainer which obtains driving information concerning driving of a moving body by a passenger or a remote worker, the moving body being switchable between autonomous driving and manual driving; a calculator which calculates a travel route according to the departure place, the destination, and the driving information, the travel route being at least one of a first route including a manual zone where the passenger or the remote worker is requested to drive or a second route not including the manual zone; and an outputter which outputs the travel route calculated.

Thereby, the same effects as those of the information processing method are provided.

Furthermore, these comprehensive or specific aspects may be implemented with a system, an apparatus, a method, an integrated circuit, a computer program, or a non-transitory recording medium such as a computer-readable CD-ROM, or any combination of a system, an apparatus, a method, an integrated circuit, a computer program, and a recording medium.

Hereinafter, specific examples of the information processing method and the information processing system according to one aspect of the present disclosure will be described with reference to the drawings. The embodiments described here all illustrate one specific examples of the present disclosure. Accordingly, numeric values, shapes, components, steps, order of steps, and the like shown in the embodiments below are exemplary, and should not be construed as limitations to the present disclosure. Moreover, among the components of the embodiments below, the components not described in an independent claim will be described as arbitrary components. The contents can also be combined in all the embodiments.

The drawings are schematic views, and are not always strictly illustrated. Accordingly, for example, the scale is not always consistent among the drawings. In the drawings, identical referential numerals are given in substantially identical configurations, and the duplication of the description thereof will be omitted or simplified.

In this specification, numeric values and ranges of numeric values are not expressions which represent only strict meanings, but expressions which also include substantially equal ranges, for example, differences of about several percent.

### Embodiment 1

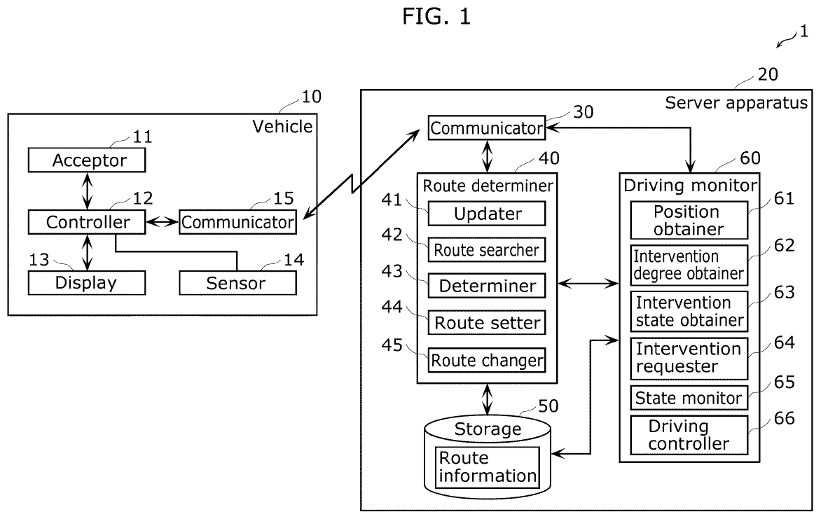

The information processing method according to the present embodiment will now be described with reference to FIGS. 1 to 13.

### [1-1. Configuration of Information Processing System]

First, the configuration of information processing system 1 according to the present embodiment will be described with reference to FIGS. 1 to 3. FIG. 1 is a block diagram illustrating the functional configuration of information processing system 1 according to the present embodiment.

As illustrated in FIG. 1, information processing system 1 includes vehicle 10 and server apparatus 20. Vehicle 10 and server apparatus 20 are communicably connected through a network (not illustrated). Information processing system 1 is a vehicle information processing system for setting the driving route of vehicle 10.

Vehicle 10 is one example of a moving body switchable between autonomous driving and manual driving. In other words, vehicle 10 has an autonomous driving mode and a manual driving mode. In the present embodiment, vehicle 10 is an autonomous vehicle switchable between autonomous driving and manual driving. The autonomous vehicle includes those usually called vehicles such as automobiles, trains, taxies, and buses. Besides the vehicles, the moving body may be an aircraft such as a drone, a hovercraft, or a ship. Driving is one example of travel, and the driving route is one example of a travel route.

Vehicle 10 includes acceptor 11, controller 12, display 13, sensor 14, and communicator 15.

Acceptor 11 accepts an input by a passenger. Acceptor 11 accepts a departure place and a destination from the passenger. Acceptor 11 also accepts driving information concerning driving of vehicle 10 by the passenger. The driving information includes a driving skill indicating whether the passenger can drive vehicle 10, for example. In other words, acceptor 11 accepts an input whether a passenger which can drive vehicle 10 is present among the passengers. The driving skill may include a driving operation executable by the passenger which can drive. For example, the driving operation executable by the passenger may be input by the passenger as the driving content acceptable to the passenger described later, or may be estimated from the driving history in the past. The driving skill may also include accuracy or proficiency of the driving operation.

Hereinafter, the passenger who can drive vehicle 10 is also referred to as driver. The term “can drive” indicates that the passenger is qualified to drive vehicle 10, and may indicate that the passenger has a driving license or has finished the driving course, for example. Furthermore, in the case where a driver is present among the passengers, acceptor 11 accepts an input of the driving content acceptable to the driver. In other words, the driving content acceptable to the driver is the information indicating the degree of intervention by the driver during manual driving. The driving content includes at least one of the content of operation or the operation time (manual driving time). For example, acceptor 11 accepts the driving content, such as “manual for all the operations”, “autonomous only for braking”, “autonomous only for acceleration and braking”, “autonomous for acceleration, braking, and steering and monitoring required”, “autonomous for acceleration, braking, and steering and monitoring not required”, and “10 minutes as the driving time”. The driving content is included in the driving information. The driving information may include the information for identifying the passenger (such as a passenger ID), the name and contact of the passenger. In other words, the driving content includes the driving operations acceptable to the driver.

Acceptor 11 may accept at least one of the driving skill or the driving content as the driving information.

In the case where route determiner 40 calculates a plurality of driving routes as candidate routes, acceptor 11 accepts a driving route selected from the candidate routes by the passenger. The candidate route is one or more driving routes from which the passenger selects the driving route.

Acceptor 11 functions as a first obtainer and a second obtainer.

Acceptor 11 is implemented with a touch panel, for example, or may be implemented with hardware keys (hardware buttons) and a slide switch. Acceptor 11 may also accept a variety of inputs using information based on a sound or a gesture.

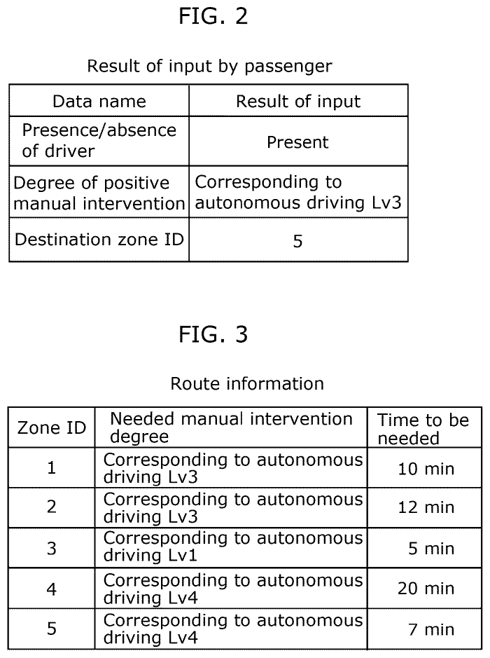

Here, the information accepted by acceptor 11 will be described with reference to FIG. 2. FIG. 2 is a table showing one example of the result of input by the passenger according to the present embodiment. The information indicating the result of input by the passenger, which is shown in FIG. 2, is included in the driving information.

As illustrated in FIG. 2, the result of input by the passenger includes the presence/absence of the driver, the degree of positive manual intervention, and a destination zone ID. The presence/absence of the driver indicates whether the passenger riding vehicle 10 can drive vehicle 10. For example, the presence/absence of the driver indicates whether the driver is present among the passengers riding vehicle 10. When acceptor 11 accepts the presence of the driver among the passengers, the result of input is “present”. The result of input about the presence/absence of the driver is one example of the driving skill.

The degree of positive manual intervention indicates the positiveness of the driver to manual intervention in driving based on the input indicating how much the driver will intervene driving during manual driving. In the present embodiment, the degree of positive manual intervention is defined as an autonomous driving level, and the result of input is “corresponding to autonomous driving level 3”. The autonomous driving level indicated by the degree of positive manual intervention is one example of the driving operation acceptable to the driver, and can be specified according to the content of operation. The destination zone ID indicates the ID of the zone including the destination. The expression “corresponding to autonomous driving level 3” means that the result of input corresponds to autonomous driving level 3. Hereinafter, “corresponding to autonomous driving level 3” is also simply referred to as “autonomous driving level 3”. The same is applied to other autonomous driving levels. The degree of positive manual intervention is one example of the acceptable driving content.

The autonomous driving levels in the present embodiment are defined as follows.

Autonomous driving level 1 is a level at which any one of acceleration (increase of speed), steering (control of the course), and braking (control) operations is autonomously performed. Autonomous driving level 2 is a level at which a plurality of operations among acceleration, steering, and braking is autonomously performed. Autonomous driving level 3 is a level at which all the acceleration, steering, and braking operations are autonomously performed and the driver drives only when needed. Autonomous driving level 4 is a level at which all the acceleration, steering, and braking operations are autonomously performed and the driver does not drive. Autonomous driving level 3 requires monitoring by the driver while autonomous driving level 4 does not require monitoring by the driver, for example. At autonomous driving levels 3 and 4, autonomous driving to the destination is executable without any driving operation by the driver. The autonomous driving level is not limited to the 4 levels described above, and may be defined as 5 levels, for example.

Hereinafter, the zones of autonomous driving levels 1 and 2 are also referred to as manual zones, and the zones of autonomous driving levels 3 and 4 are also referred to as autonomous zones.

The expression “corresponding to autonomous driving level 3” shown in FIG. 2 means that an input is performed through acceptor 11, for example, the input indicating that the driver does not perform any of acceleration, steering, and braking operations and will drive when needed, e.g., in emergency.

With reference to FIG. 1, controller 12 controls the components of vehicle 10. For example, controller 12 controls transmission/reception of various pieces of information. Controller 12 performs a variety of processings based on the result of sensing by sensor 14. For example, based on the image of the passenger obtained from sensor 14, controller 12 may identify the passenger through authentication processing such as facial authentication. The information needed for facial authentication is preliminarily stored in storage 50. For example, based on the pressure data obtained from sensor 14 when the steering wheel is held, controller 12 may determine whether the driver is performing a necessary driving operation.

Controller 12 may also control driving of vehicle 10. For example, based on control information from server apparatus 20, controller 12 may stop vehicle 10 which is driving, or may decelerate vehicle 10.

Controller 12 is implemented with a microcomputer or a processor, for example.

Display 13 displays information for inputting the driving information from the passenger and information about the driving route. The display (image) of the information for inputting the driving information from the passenger is one example of an interface. For example, display 13 as an interface presents a display for accepting at least one input of the driving skill or the acceptable driving content. The display is a display for accepting at least one input of the presence/absence of the driver, the driving operations executable by the driver, the driving operations acceptable to the driver, and the operation time. The display may be a display for obtaining at least the driving skill of the passenger. The interface is not limited to an image, and may be a sound.

Display 13 displays the candidate routes for selecting the driving route, as the information about the driving route. For example, as the information about the driving route, display 13 displays the candidate routes and the times to be needed to the destination. The time to be needed is preset for each zone. Display 13 may display the degree of manual intervention (such as the autonomous driving level) needed in the manual zone as the information about the driving route. Display 13 displays the information about the driving route with letters, tables, and figures. Display 13 may display the information about the driving route superimposed on a map.

Display 13 displays a driving route selected from the candidate routes by the passenger. Display 13 displays a notification (such as an alert) that one of autonomous driving and manual driving is switched to the other during driving. Display 13 is one example of a presentation apparatus which presents a predetermined notification to the driver. Display 13 also functions as an outputter which outputs the driving route.

For example, display 13 is implemented with a liquid crystal panel, or may be implemented with another display panel such as an organic EL panel. Display 13 may also include a backlight.

Sensor 14 detects the state of the passenger. Sensor 14 detects at least the state of the driver. For example, sensor 14 detects the position of the driver inside the vehicle, whether the driver is in a state where he/she can drive, and whether the driver is performing a needed manual intervention.

For example, sensor 14 is implemented with a camera which captures the inside of the vehicle or a sensor (such as a pressure-sensitive sensor) included in the steering wheel to detect whether the passenger holds the steering wheel.

Sensor 14 may further include a variety of sensors for autonomous driving of vehicle 10. Sensor 14 may include one or more cameras which capture the surroundings of vehicle 10, and one or more sensors which detect at least one of the position, the speed, the acceleration, the jerk (jolt), the steering angle, or the remaining amount of fuel or battery of vehicle 10.

Communicator 15 communicates with server apparatus 20. Communicator 15 is implemented with a communication circuit (communication module), for example. Communicator 15 transmits the input information, which indicates the input accepted by acceptor 11, to server apparatus 20. Communicator 15 may transmit the result of sensing by sensor 14 to server apparatus 20. Communicator 15 obtains the information indicating the driving route from server apparatus 20. The driving information is included in the input information.

At least one of the components included in vehicle 10 may be implemented with a component included in a navigation system mounted on vehicle 10. For example, acceptor 11 and display 13 may be implemented with a display panel included in the navigation system and having a touch panel function.

Server apparatus 20 performs processing to calculate the driving route for vehicle 10 and processing to monitor driving of vehicle 10. Server apparatus 20 is a server including a personal computer, for example. Server apparatus 20 includes communicator 30, route determiner 40, storage 50, and driving monitor 60.

Communicator 30 communicates with vehicle 10. Communicator 30 is implemented with a communication circuit (communication module), for example.

Route determiner 40 calculates the driving route for vehicle 10. Because vehicle 10 is switchable between autonomous driving and manual driving, route determiner 40 calculates at least one driving route of the driving route including the manual zone where the driver is requested to drive and the driving route not including the manual zone. Hereinafter, the driving route including the manual zone is also referred to as first route, and the driving route not including the manual zone is also referred to as a second route. Route determiner 40 is one example of a calculator which calculates the driving route for vehicle 10.

Route determiner 40 includes updater 41, route searcher 42, determiner 43, route setter 44, and route changer 45.

Updater 41 updates the route information (see FIG. 3 described later) stored in storage 50. Updater 41 obtains a road condition through communicator 30 from an external apparatus, and updates the route information based on the obtained road condition. The external apparatus is a server apparatus which manages the road condition, for example. The route information is the information that includes information about a plurality of zones which forms a driving route and that is used when determiner 43 extracts the driving route, for example. The road condition is a condition of roads which dynamically changes during driving of vehicle 10, such as traffic jams, traffic accidents, natural disasters, and traffic regulations. The road condition may be a condition on a road indicated by a road traffic information, for example. The road condition may include an increase/decrease in people or the presence/absence of an emergency vehicle or a vehicle at rest near roads within the zone, for example. The road condition is one example of a traffic situation, and the information indicating the road condition is one example of the traffic situation information.

Route searcher 42 searches for a route which can be a candidate of the driving route, from the map information stored in storage 50, the departure place, and the destination. Route searcher 42 searches for a plurality of routes, for example. Hereinafter, the driving route searched by route searcher 42 is also referred to as temporary route.

Based on the result of input by the passenger, determiner 43 extracts the driving route which can reach the destination, from the temporary routes searched by route searcher 42. In the present embodiment, determiner 43 extracts a temporary route satisfying the result of input by the passenger from the temporary routes as a candidate route. For example, determiner 43 determines whether the autonomous driving level needed in the manual zone included in the temporary route satisfies the autonomous driving level indicated by the result of input by the passenger, and if so, extracts the determined temporary route including the manual zone as a candidate route. Among the results of input by the passenger, determiner 43 performs the processing above based on at least the result of input of the presence/absence of the driver. Among the results of input by the passenger, determiner 43 may further perform the processing based on the information indicating the degree of positive manual intervention.

Route setter 44 sets the driving route for vehicle 10. For example, route setter 44 sets the driving route for vehicle 10 by registering the driving route selected among the candidate routes by passenger as the driving route for vehicle 10. When determiner 43 extracts one candidate route, route setter 44 may set the candidate route as the driving route for vehicle 10.

Route changer 45 changes the driving route set by route setter 44. For example, when the road condition has changed from the time when route setter 44 set the driving route, route changer 45 determines whether the change of the driving route is needed, and if so, changes the driving route. When the route information is changed from the time when route setter 44 set the driving route, route changer 45 performs processing for changing the driving route.

As described above, based on the driving information (such as the driving skill, or the driving skill and the degree of positive manual intervention), route determiner 40 calculates the driving route (candidate route) to be suggested to the passenger. For example, based on the presence/absence of the driver or the degree of positive manual intervention of the driver in the presence of the driver, route determiner 40 calculates the driving route to be suggested to the passenger.

Storage 50 stores the information needed for the processings to be executed by the processors included in information processing system 1. For example, storage 50 stores the route information. FIG. 3 is a table showing one example of the route information according to the present embodiment.

As illustrated in FIG. 3, the route information is a table in which the zone ID, the degree of manual intervention needed in the zone, and the time to be needed are associated. The zone ID is the identification information for identifying a predetermined area of a road. The degree of manual intervention needed indicates the driving operation(s) acceptable to the driver during manual driving, and is indicated with the autonomous driving level in the present embodiment. In other words, an autonomous driving level for driving the zone is set for each zone. The time to be needed indicates the time needed when driving the zone according to the degree of manual intervention corresponding to the zone. For example, the time to be needed indicates that it takes 10 minutes for driving the zone of zone ID “1” at autonomous driving level 3.

Instead of or with the time to be needed, the table may include the distance of each zone. The distance may be the distance for manual driving.

Storage 50 may store the information about the passenger and the map information. For example, storage 50 may store a table in which a passenger identified through facial authentication is associated with the driving information of the passenger (e.g., at least one of the driving skill or the driving content). In the table, furthermore, the passenger may be associated with standard information concerning the degree of positive manual intervention thereof during driving. The standard information usually includes the content of operation when the passenger is driving and the manual driving time when the passenger performs manual driving, for example. The standard information may be generated in the past based on the history of the driving information, or may be generated by an input from the passenger. For example, the standard information may include execution of operations such as acceleration and steering as the content of operation, or may include a manual driving time of 15 minutes or less.

In information processing system 1 where sensor 14 is a camera, for example, the passenger is identified through facial authentication based on the image taken by sensor 14, and the driving information of the passenger identified from the table stored in storage 50 is obtained. Thereby, information processing system 1 can obtain the driving information of the passenger without accepting an input by the passenger. Using the table including the standard information, information processing system 1 can display the standard information of the passenger identified through facial authentication on display 13. Thereby, the passenger can smoothly input the driving information.

Storage 50 is implemented with a semiconductor memory, for example.

Driving monitor 60 monitors driving of vehicle 10. Driving monitor 60 monitors whether vehicle 10 is normally driving. When vehicle 10 is not normally driving, driving monitor 60 also performs processing to inform that vehicle 10 is not normally driving or to restrict driving of vehicle 10. Driving monitor 60 includes position obtainer 61, intervention degree obtainer 62, intervention state obtainer 63, intervention requester 64, state monitor 65, and driving controller 66.

Position obtainer 61 obtains the current position of vehicle 10. For example, position obtainer 61 is implemented with a global positioning system (GPS) module which obtains the current position by obtaining a GPS signal (radio waves transmitted from a satellite), and measuring the current position of vehicle 10 based on the GPS signal obtained. Position obtainer 61 can also obtain the current position of vehicle 10 by any method other than the above method. Position obtainer 61 may obtain the current position by matching (point groups matching) using normal distributions transform (NDT). Alternatively, position obtainer 61 may obtain the current position by simultaneous localization and mapping (SLAM) processing, or may obtain the current position by other methods.

By obtaining the current position by position obtainer 61, the zone (area) in which vehicle 10 is currently driving in the map information can be identified.

When the current driving zone is a manual zone, intervention degree obtainer 62 obtains the degree of manual intervention needed in the manual zone. Based on the route information, intervention degree obtainer 62 obtains the degree of manual intervention corresponding to the zone including the current position of vehicle 10 obtained by position obtainer 61. In the present embodiment, intervention degree obtainer 62 obtains the autonomous driving level as the degree of manual intervention in the manual zone.

Intervention state obtainer 63 obtains the current state of manual intervention of the driver. The state of manual intervention includes the state where the driver holds the steering wheel or sees in front of vehicle 10. Intervention state obtainer 63 obtains the current state of manual intervention by the driver based on the result of sensing obtained from vehicle 10. Intervention state obtainer 63 may obtain the current state of manual intervention by the driver through image analysis of the captured image of the driver, or may obtain the current state of manual intervention by the driver based on the pressure data when the driver holds the steering wheel. The image and the pressure data are one example of the result of sensing.

Intervention requester 64 determines whether the current state of manual intervention by the driver satisfies the degree of manual intervention needed in the manual zone in which the vehicle is driving. When the degree of manual intervention needed is not satisfied, intervention requester 64 requests of the driver to satisfy the degree of manual intervention needed in the manual zone. In other words, when the degree of manual intervention needed is not satisfied, intervention requester 64 presents a request for manual intervention. The expression “satisfy” means that the autonomous driving level based on the current state of manual intervention by the driver is equal to or less than the autonomous driving level based on the route information. For example, in the case where the autonomous driving level based on the route information is 3, intervention requester 64 determines that the degree of manual intervention needed is satisfied when the autonomous driving level based on the current state of manual intervention by the driver is any of 1 to 3, and determines that the degree of manual intervention needed is not satisfied when the autonomous driving level based on the current state of manual intervention by the driver is 4.

State monitor 65 monitors whether the driver is in the state where he/she can drive. For example, by image analysis of the captured image of the driver, state monitor 65 determines whether the driver is in the state where he/she can drive. In other words, when intervention requester 64 requests for a manual intervention, state monitor 65 monitors whether the driver can accept the request. The state where the driver cannot drive includes that where the driver is sleeping or sits in a seat different from the driver's seat.

Driving controller 66 restricts driving of vehicle 10 when a manual intervention based on the route information is not being performed. The expression “a manual intervention based on the route information is not being performed” indicates the state where the driver is not performing a manual intervention needed in the manual zone or is not in the state where the driver can perform a needed manual intervention, for example. When a manual intervention based on the route information is not being performed, driving controller 66 may stop or decelerate vehicle 10. In this case, vehicle 10 may be stopped after a safety operation such as pulling over to the shoulder. In this case, driving controller 66 transmits control information for restricting driving of vehicle 10 through communicator 30 to vehicle 10. When a manual intervention based on the route information is not being performed, driving controller 66 may cause route changer 45 to change the driving route to another driving route which vehicle 10 is allowed to drive even in the current state of manual intervention. The change of the driving route is also included in the restriction of driving of vehicle 10.

As described above, information processing system 1 according to the present embodiment includes acceptor 11 which accepts the departure place, the destination, and the driving information before driving of vehicle 10, route determiner 40 which calculates the driving route, which is at least one of the first route or the second route, according to the departure place, the destination, and the driving information, and display 13 which displays the calculated driving route. Thereby, the calculated driving route is a route corresponding to the driving information of the passenger. The driving route is, for example, a driving route corresponding to the presence/absence of the driver in vehicle 10.

### [1-2. Operation of Information Processing System]

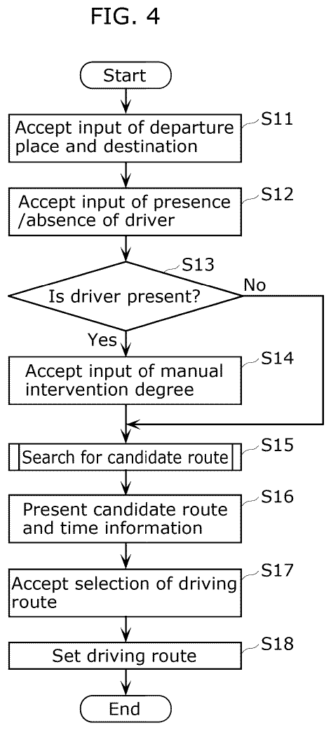

Subsequently, the operation of information processing system 1 described above will be described with reference to FIGS. 4 to 13.

### <Operation Before Driving>

Initially, the operation before driving of vehicle 10 in information processing system 1 will be described. FIG. 4 is a flowchart illustrating an operation before driving of vehicle 10 in information processing system 1 according to the present embodiment. FIG. 4 illustrates mainly the operations of vehicle 10 and route determiner 40. The operation illustrated in FIG. 4 will be described as an operation during a period from riding of the passenger on vehicle 10 to the start of moving of vehicle 10, but not limited thereto.

As illustrated in FIG. 4, acceptor 11 accepts an input of the departure place and the destination before driving of vehicle 10 (S11). When acceptor 11 is mounted on vehicle 10, acceptor 11 may accept at least an input of the destination. In this case, for example, the current position obtained by position obtainer 61 may be used as a departure place.

Next, acceptor 11 accepts an input of the presence/absence of the driver among passengers (S12). In other words, acceptor 11 obtains a driving skill indicating that a passenger can drive vehicle 10. Step S12 is one example of obtaining the driving information including the driving skill indicating that the passenger can drive vehicle 10.

Next, when the driver is present (Yes in S13), acceptor 11 further accepts an input of the degree of manual intervention of the driver (S14). In the present embodiment, acceptor 11 accepts an input of the degree of positive manual intervention as a degree of manual intervention. For example, acceptor 11 accepts a content of operation described above. Instead of the content of operation above, acceptor 11 may accept an input of the autonomous driving level as the degree of positive manual intervention. The content of operation is information from which the driving operation acceptable to the passenger can be specified, and is information from which the autonomous driving level can be specified in the present embodiment.

Acceptor 11 may also accept an input of a manual driving time as the degree of positive manual intervention, for example. In other words, step S14 is the one for confirming the will of the driver to drive. It can also be said that step S14 is the one for obtaining the driving content acceptable to the driver.

When the driver is absent (No in S13), acceptor 11 does not perform the processing in step S14.

Controller 12 transmits the pieces of information input in the steps above through communicator 15 to server apparatus 20. For example, controller 12 transmits the information shown in FIG. 2 (which indicates the result of input by the passenger) to server apparatus 20. At this time, controller 12 sets the degree of positive manual intervention based on the content of operation obtained in step S14. Using the table based on the definition of the autonomous driving level above, controller 12 may set the autonomous driving level corresponding to the content of operation obtained in step S14.

The degree of positive manual intervention may be set by server apparatus 20. In this case, controller 12 transmits the information corresponding to the content of operation obtained in step S14 to server apparatus 20.

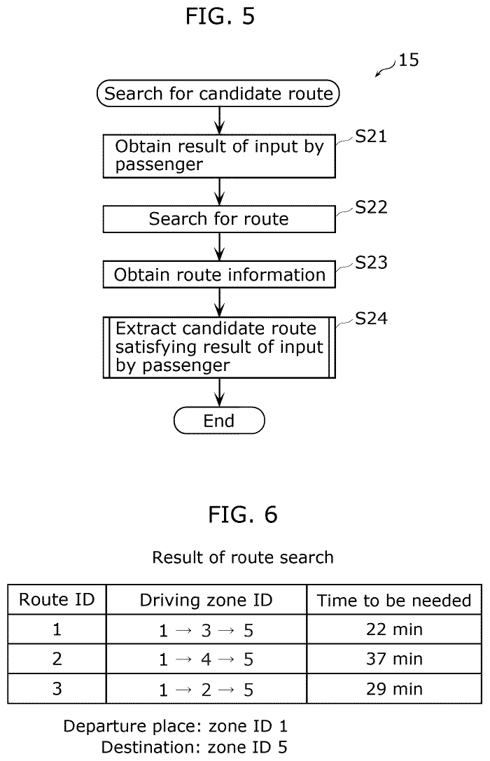

Next, route searcher 42 searches for the candidate route based on the information indicating the result of input by the passenger and the map information (S15). FIG. 5 is a flowchart illustrating one example of the operation (S15) to search for the candidate route illustrated in FIG. 4.

As illustrated in FIG. 5, route searcher 42 obtains the result of input by the passenger, which is transmitted from vehicle 10, through communicator 30 (S21). Route searcher 42 then searches for the route to the destination based on the departure place, the destination, and the map information (S22). Route searcher 42 may search for a plurality of routes. FIG. 6 is a table showing one example of the result of route search according to the present embodiment. FIG. 6 shows the result of route search where the departure place has zone ID “1” and the destination has zone ID “5”. Step S22 is one example of calculation of the temporary route.

As shown in FIG. 6, the result of route search includes an route ID for identifying the searched route, the driving zone ID, and the time to be needed. In the example of FIG. 6, there are three temporary routes searched. Route searcher 42 outputs the result of route search to determiner 43. The number of zones between the departure place and the destination is not limited to 1, and may be 2 or more.

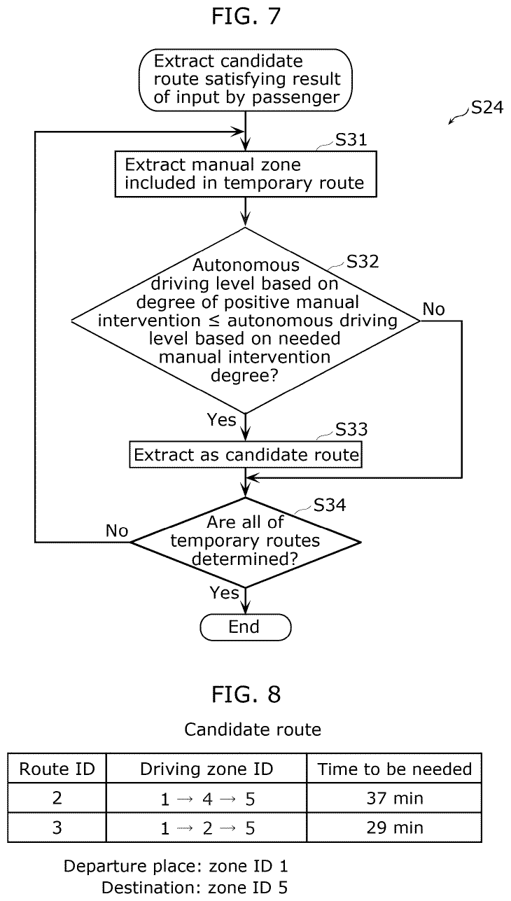

Again with reference to FIG. 5, determiner 43 obtains the route information from storage 50 (S23). Thereby, determiner 43 can obtain the degree of manual intervention needed in each zone included in the temporary route searched by route searcher 42. Determiner 43 then extracts a candidate route satisfying the result of input by the passenger from the result of route search (S24). From the result of route search, determiner 43 extracts the temporary route (driving route) satisfying the result of input by the passenger, as a candidate route. For example, determiner 43 extracts the candidate route by determining whether there is a temporary route which satisfies the result of input by the passenger and can reach the destination. In step S24, determiner 43 may extract one driving route as the candidate route, or may extract a plurality of driving routes as candidate routes. FIG. 7 is a flowchart illustrating one example of the operation (S24) to extract the candidate route illustrated in FIG. 5.

As illustrated in FIG. 7, determiner 43 extracts the manual zone included in the temporary route (S31), and determines whether the extracted manual zone is a zone corresponding to the driving content. For example, determiner 43 determines whether the driving operation requested for driving of vehicle 10 corresponds to that included in the driving content. In the present embodiment, determiner 43 determines whether the autonomous driving level based on the degree of positive manual intervention included in the result of input by the passenger is equal to or less than the autonomous driving level based on the degree of manual intervention needed (S32). In step S32, it is determined whether the degree of manual intervention needed in the manual zone satisfies the result of input by the passenger.

As one example, a temporary route having route ID “1” shown in FIG. 6 will be described. In this example, zone ID “3” is extracted as the manual zone in step S31. In zone ID “3”, the autonomous driving level (e.g., autonomous driving level 3 shown in FIG. 2) based on the degree of positive manual intervention included in the result of input by the passenger is higher than that (e.g., autonomous driving level 1 shown in FIG. 3) based on the degree of manual intervention needed. Thus, it is determined as No in step S3, and the temporary route having route ID “1” and including zone ID “3” is not extracted as a candidate route.

As another example, a temporary route represented by route ID “2” shown in FIG. 6 will be described. In this example, the zone represented by zone ID “4” is extracted as the manual zone in step S31. In zone ID “4”, the autonomous driving level (e.g., autonomous driving level 3 shown in FIG. 2) based on the degree of positive manual intervention included in the result of input by the passenger is equal to or less than that (e.g., autonomous driving level 4 shown in FIG. 3) based on the degree of manual intervention needed. Thus, it is determined as Yes in step S32, and the temporary route having route ID “2” and including zone ID “4” is extracted as a candidate route (S33).

Yes in step S32 is one example of correspondence of the driving operation requested for driving of vehicle 10 to that included in the driving content. The zone determined as Yes in step S32, i.e., the zone satisfying the autonomous driving level based on the degree of positive manual intervention included in the result of input by the passenger is one example of the zone in which the driving operation requested for driving of vehicle 10 corresponds to that included in the driving content. The zone determined as Yes in step S32 is one example of the zone corresponding to the driving content acceptable to the driver.

In step S32, the determination is performed using the driving operations acceptable to the driver included in the driving content, but not limited to this. For example, in step S32, using the driving operation requested for driving of vehicle 10 and that executable by the driver included in the driving skill, it may be determined whether these operations correspond to each other in the zone.

Next, determiner 43 determines whether all the temporary routes are determined (S34). When all the temporary routes are determined (Yes in S34), determiner 43 terminates the processing to extract the candidate route. When not all the temporary routes are determined (No in S34), the processing returns to step S31 to perform the processings after step S31 on the residual temporary routes.

Thus, determiner 43 performs the determination in step S32 on all the temporary routes. Determiner 43 specifies the zone in which vehicle 10 cannot travel before the candidate route is presented to the passenger, and extracts a candidate route corresponding to the zone. Specifically, determiner 43 extracts a temporary route not including the zone as a candidate route. The time before the candidate route is presented to the passenger is ahead of the time when vehicle 10 starts driving.

In the present embodiment, as shown in FIG. 8, routes represented by route IDs “2” and “3” are extracted as candidate routes. FIG. 8 is a table showing one example of the candidate route according to the present embodiment. In the example of FIG. 8, the number of candidate routes is 2, but not particularly limited. The number of candidate routes may be 1, or may be 3 or more. Routes represented by route IDs “2” and “3” are one example of the second route.

For example, when the degree of positive manual intervention is autonomous driving level 1, determiner 43 determines that the route represented by route ID “1”, which is a temporary route including the zone represented by zone ID “3” shown in FIG. 6, is a candidate route. In this case, zone ID “3” is a zone corresponding to the driving content, and the temporary route having route ID “1” is extracted as a candidate route. Route ID “1” is a temporary route (driving route) including the manual zone and one example of the first route.

In the description above, determiner 43 extracts the candidate route in step S24 using both of the presence/absence of the driver and the degree of positive manual intervention (e.g., the content of operation) in the result of input by the passenger, but not limited to this. For example, in step S24, determiner 43 may extract the candidate route based on the presence/absence of the driver in the result of input by the passenger. In other words, determiner 43 may extract the candidate route based on the driving skill. In short, in step S24, determiner 43 may extract the candidate route based on at least one of the driving skill or the driving content.

In the example described above, route searcher 42 searches for a plurality of temporary routes (e.g., all the temporary routes) and then determiner 43 determines whether each of the temporary routes is extracted as a candidate route, but not limited to this. For example, the route search by route searcher 42 and the determination by determiner 43 may be repeatedly performed. For example, every time when route searcher 42 detects one temporary route, determiner 43 may determine whether the one temporary route is extracted as a candidate route.

In the presence of the driver, determiner 43 extracts at least one of the temporary route including the manual zone or the temporary route not including the manual zone as a candidate route. For example, when the driving information indicates that the driver ca drive or when Yes in step S13, at least one of the first route or the second route is calculated in step S15. In the absence of the driver, the temporary route not including the manual zone is extracted as a candidate route from the temporary route including the manual zone and the temporary route not including the manual zone. For example, when the driving information indicates that the driver cannot drive or when No in step S13, determiner 43 calculates only the second route of the first route and the second route in step S15. Step S15 is one example of calculation of the driving route.

Again with reference to FIG. 4, after the candidate route is searched in step S15, the result of search including the candidate route is output. In other words, the result of search is presented to the passenger. In the present embodiment, a plurality of driving routes is extracted as candidate routes. Thus, determiner 43 outputs the plurality of candidate routes and the time information indicating the times to be needed to vehicle 10.

When controller 12 of vehicle 10 obtains the candidate route and the time information, controller 12 presents the obtained candidate route and time information to the passenger (S16). In the present embodiment, controller 12 causes display 13 to display a plurality of candidate routes and a plurality of pieces of time information. In other words, controller 12 causes display 13 to display a plurality of driving routes as candidate routes. For example, controller 12 may cause display 13 to display the candidate routes shown in FIG. 8. Controller 12 may present at least a candidate route to the passenger in step S16. Step S16 is one example of output of the driving route.

Next, when controller 12 accepts the selection of the driving route through acceptor 11 (S17), controller 12 outputs the information indicating the accepted driving route to server apparatus 20. After obtaining the information, route setter 44 sets the driving route selected by the passenger as a driving route for vehicle 10 (S18). This causes vehicle 10 to start driving, and then a guide is performed according to the set driving route (e.g., a guide by a navigation system).

### <Determination Whether Manual Intervention is Appropriate>

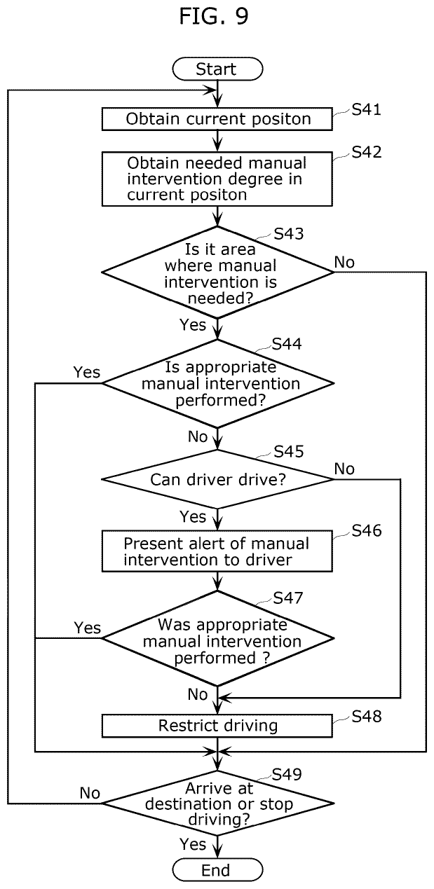

Subsequently, the operation to determine whether the manual intervention in information processing system 1 is appropriate will be described. FIG. 9 is a flowchart illustrating an operation to determine whether the manual intervention by the driver during driving of vehicle 10 is appropriate, in information processing system 1 according to the present embodiment. FIG. 9 illustrates the operation mainly in driving monitor 60.

As illustrated in FIG. 9, position obtainer 61 obtains the current position of vehicle 10 (S41). Position obtainer 61 outputs the information indicating the obtained current position to intervention degree obtainer 62.

Next, intervention degree obtainer 62 obtains the degree of manual intervention needed in the obtained current position (S42). For example, based on the route information, intervention degree obtainer 62 obtains the degree of manual intervention needed. For example, when the zone ID of the current position is “3”, intervention degree obtainer 62 obtains “corresponding to autonomous driving level 1” as a degree of manual intervention needed. Intervention degree obtainer 62 then determines whether the current position is in an area (zone) where a manual intervention is needed (S43). In the present embodiment, when the autonomous driving level set to the zone including the current position is autonomous driving level 1 or 2, intervention degree obtainer 62 determines that a manual intervention is needed. When the autonomous driving level set to the zone including the current position is autonomous driving level 3 or 4, intervention degree obtainer 62 determines that a manual intervention is not needed in this zone. Intervention degree obtainer 62 outputs the result of determination to intervention state obtainer 63. The operation after step S44 is performed when the current driving route is the first route.

Next, when intervention state obtainer 63 obtains the result of determination from intervention degree obtainer 62, the result indicating that a manual intervention is needed (Yes in S43), intervention state obtainer 63 determines whether an appropriate manual intervention is being performed by the current driver (S44). For example, intervention state obtainer 63 may determine whether vehicle 10 is being driven by a driver who can drive the manual zone in the current driving route (first route). For example, intervention state obtainer 63 may perform the determination in step S44 based on the result of input by the passenger. Alternatively, for example, based on the presence/absence of the driver, intervention state obtainer 63 may perform the above determination whether vehicle 10 is being driven by a passenger who cannot drive the manual zone. Alternatively, for example, intervention state obtainer 63 may perform the determination in step S44 by determining the current degree of manual intervention of the driver and determining whether the degree of manual intervention indicated by the result of determination satisfies the degree of manual intervention needed, which is obtained in step S42. In the present embodiment, when the current degree of manual intervention by the driver is equal to or less than the autonomous driving level set to the zone including the current position, intervention state obtainer 63 determines that an appropriate manual intervention is being performed. When the current degree of manual intervention by the driver is higher than that set to the zone including the current position, intervention state obtainer 63 determines that an appropriate manual intervention is not performed. Intervention state obtainer 63 outputs the result of determination to state monitor 65 and driving controller 66. For example, intervention state obtainer 63 outputs at least a result of determination indicating that an appropriate manual intervention is not performed, to state monitor 65 and driving controller 66.

Intervention state obtainer 63 determines the current degree of manual intervention by the driver based on the result of sensing from sensor 14. In the present embodiment, as determination of the degree of manual intervention, intervention state obtainer 63 determines at which level the current autonomous driving level is. Thereby, the current degree of manual intervention by the driver can be obtained.

Thus, in step S44, intervention state obtainer 63 determines whether vehicle 10 is being driven in the manual zone of the first route by a driver who can drive the manual zone of the first route. In step S44, intervention state obtainer 63 may further determine whether the driving operation corresponding to the needed autonomous driving level is being performed. In other words, intervention state obtainer 63 may determine whether the driving operation specified by the content of operation is being performed. The determination in step S44 is one example of determination of the presence/absence of driving by a passenger.

Next, when state monitor 65 obtains the result of determination indicating that an appropriate manual intervention is not performed, from intervention state obtainer 63 (No in S44), state monitor 65 determines whether the driver can drive (S45). Based on the result of sensing from sensor 14, state monitor 65 determines whether the current driver can drive. State monitor 65 outputs the result of determination to intervention requester 64 and driving controller 66. For example, state monitor 65 outputs the result of determination that the driver can drive to intervention requester 64, and outputs the result of determination that the driver cannot drive to driving controller 66.

Next, when intervention requester 64 obtains the result of determination that the driver can drive from state monitor 65 (Yes in S45), intervention requester 64 presents an alert of manual intervention to the driver (S46). For example, intervention requester 64 causes display 13 to present a needed manual intervention to the driver. In the present embodiment, intervention requester 64 causes display 13 to display an alert which notifies the driver of a driving request. With or instead of the display by display 13, intervention requester 64 may present an alert using at least one of a sound, light, or vibration.

Next, intervention state obtainer 63 determines again whether an appropriate manual intervention is performed by the driver (S47). The processing in step S47 is the same as that in step S44, and the description thereof will be omitted. Intervention state obtainer 63 outputs the result of determination to driving controller 66.

When driving controller 66 obtains the result of determination that the driver cannot drive, from state monitor 65 (No in S45) or obtains the result of determination that an appropriate manual intervention is not performed, from intervention state obtainer 63 (No in S47), driving controller 66 restricts driving of vehicle 10 (S48). For example, driving controller 66 may restrict driving of vehicle 10 by outputting control information for stopping or decelerating vehicle 10 through communicator 30. For example, driving controller 66 may also restrict driving of vehicle 10 by causing route changer 45 to change the driving route.

Thus, when it is determined that vehicle 10 is not being driven by the passenger who can drive the manual zone of the first route (No in S45 or No in S47), driving controller 66 outputs an instruction to restrict driving of vehicle 10. Thereby, driving controller 66 ensures safety for driving of vehicle 10.

Moreover, when driving controller 66 obtains the result of determination that a manual intervention is not needed from intervention degree obtainer 62 (No in S43), obtains the result of determination that an appropriate manual intervention is performed from intervention state obtainer 63 (Yes in S47), or restricts driving of vehicle 10, driving controller 66 determines whether vehicle 10 has arrived at the destination or stops driving (S49). When driving controller 66 determines that vehicle 10 has arrived at the destination or stopped driving (Yes in S49), driving monitor 60 terminates the operation during driving shown in FIG. 9. When driving controller 66 determines that vehicle 10 has not arrived at the destination or does not stop driving (No in S49), the processing returns to step S41, and driving monitor 60 repeatedly performs the operation during driving shown in FIG. 9.

The operation shown in FIG. 9 can be performed at any timing. The operation may be performed successively, may be performed periodically, or may be performed every time when switching between autonomous driving and manual driving is performed.

For example, in the case where the driving route is the first route, intervention requester 64 may notify the driver of a driving request by displaying an alert through display 13 when vehicle 10 reaches the manual zone of the first route or a place that is a predetermined distance to the manual zone.

### <Resetting of Driving Route>

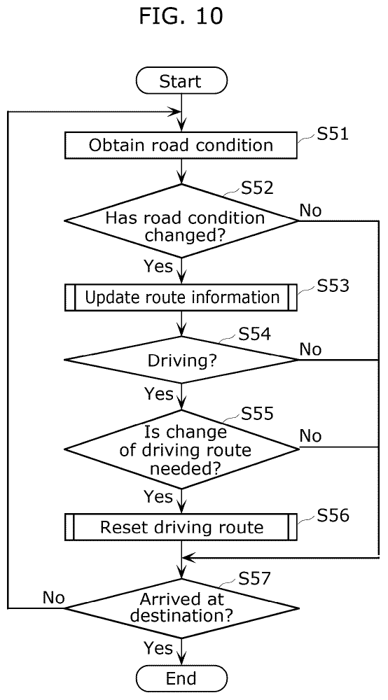

Subsequently, the operation to reset the driving route in information processing system 1 will be described. FIG. 10 is a flowchart illustrating an operation to reset the driving route in information processing system 1 according to the present embodiment. FIG. 10 illustrates mainly the operation in route determiner 40. The operation illustrated in FIG. 10 is performed after the operation illustrated in FIG. 4 is completed. In the description below, the operation illustrated in FIG. 10 is performed during driving of vehicle 10, but not limited to this.

As illustrated in FIG. 10, updater 41 obtains the road condition through communicator 30 (S51). Step S51 is one example of obtaining of traffic situation information. Updater 41 then determines whether the road condition has changed from that when the driving information was accepted (S52). When the condition in the driving route, such as traffic jams, traffic accidents, natural disasters, and traffic regulations, has changed compared to that when the driving information was accepted, updater 41 determines that the road condition in the driving route has changed. The expression “condition changes” includes occurrence or elimination of traffic jams, traffic accidents, natural disasters, and traffic regulations compared to the condition when the driving information was accepted.

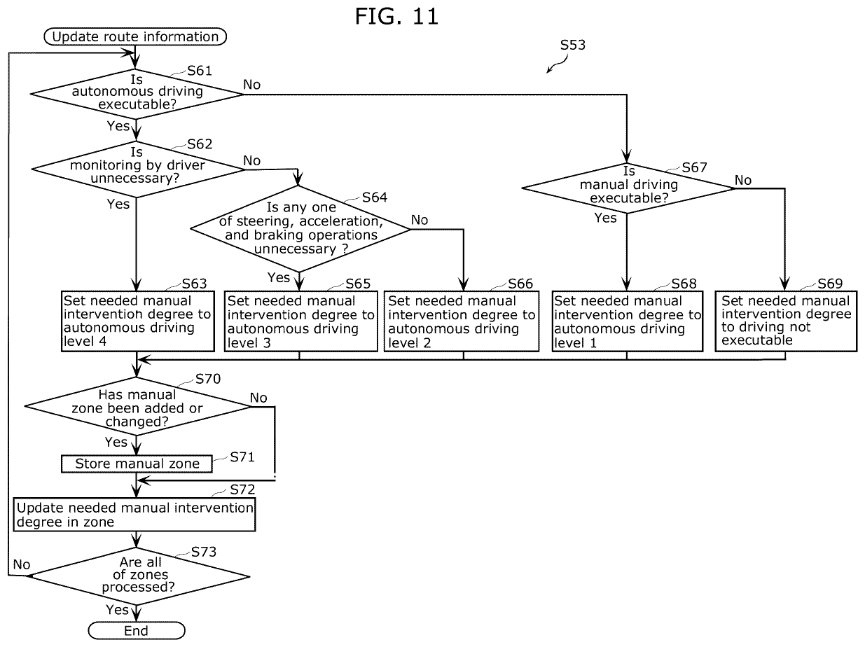

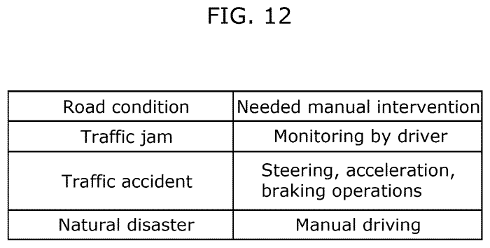

Next, when the road condition has changed (Yes in S52), updater 41 updates the route information (S53). Updater 41 determines whether the manual zone is added or changed in the driving route due to a change in road condition, and updates the route information based on the result of determination. FIG. 11 is a flowchart illustrating one example of the operation to update the route information (S53), which is illustrated in FIG. 10. The determination processing in steps S61, S62, S64, and S67 illustrated in FIG. 11 is performed using a table shown in FIG. 12, for example. FIG. 12 shows one example of the table in which the road condition and the needed manual intervention according to the present embodiment are associated.

As illustrated in FIG. 11, updater 41 first determines whether autonomous driving is executable (S61). For example, when a traffic jam or a traffic accident occurs, the needed manual intervention in this case does not include manual driving. Thus, updater 41 determines that autonomous driving is executable. When a natural disaster occurs, the needed manual intervention in this case includes manual driving. Thus, updater 41 determines that autonomous driving is not executable.

Next, when autonomous driving is executable (Yes in S61), updater 41 determines whether monitoring by the driver (e.g., monitoring of the front by the driver) is unnecessary when autonomous driving is performed (S62). For example, when a traffic accident occurs, updater 41 determines that monitoring by the driver is unnecessary because the needed manual intervention in this case does not include monitoring by the driver. When a traffic jam occurs, updater 41 determines that monitoring by the driver is needed because the needed manual intervention in this case includes monitoring by the driver.

Next, when monitoring by the driver is unnecessary (Yes in S62), updater 41 sets the degree of manual intervention needed in the zone to autonomous driving level 4 (S63). When monitoring by the driver is needed (No in S62), updater 41 determines whether any of the steering, acceleration, and braking operations is unnecessary (S64). For example, when a traffic accident occurs, which includes the steering, acceleration, and braking operations, updater 41 determines that all the steering, acceleration, and braking operations, but not any of them, are needed.

Next, when any one of the steering, acceleration, and braking operations is unnecessary (Yes in S64), updater 41 sets the degree of manual intervention needed in the zone to autonomous driving level 3 (S65). When all the steering, acceleration, and braking operations are needed (No in S64), updater 41 sets the degree of manual intervention needed in the zone to autonomous driving level 2 (S66).

When autonomous driving is not executable (No in S61), updater 41 determines whether manual driving is executable (S67). For example, based on whether driving in the zone is executable when manual driving is performed, updater 41 may determine whether manual driving is executable. For example, when the zone is closed to traffic, updater 41 determines that manual driving is not executable.

Next, when manual driving is executable (Yes in S67), updater 41 sets the degree of manual intervention needed to autonomous driving level 1 (S68). When manual driving is not executable (No in S67), updater 41 sets the degree of manual intervention needed to driving not executable (S69). A change in road condition may not cause a change in autonomous driving level in some cases.

Next, based on the degree of manual intervention set above and the degree of manual intervention needed which is included in the route information, updater 41 determines whether the manual zone is added or changed in the zone (S70). The addition of the manual zone includes a change of a zone from an autonomous zone to a manual zone. The change of the manual zone includes a change in autonomous driving level of the manual zone, and includes a reduction in autonomous driving level (an increase in load of manual driving), for example. Thus, when the load of manual driving is increased, updater 41 determines that the manual zone is added or changed.

Next, when the manual zone is added or changed (Yes in S70), updater 41 stores the zone (S71), and updates the degree of intervention needed in the zone (S72). Updater 41 then determines whether all the zones are processed (S73). When all the zones are processed (Yes in S73), updater 41 terminates the processing to update the route information. When all the zones are not processed (No in S73), the processing from step S61 is performed on the residual zones.

Again with reference to FIG. 10, route changer 45 determines whether vehicle 10 is driving at present (S54). From the result of measurement by the speed sensor in vehicle 10, route changer 45 may determine whether vehicle 10 is driving. When vehicle 10 is driving at present (Yes in S54), route changer 45 determines whether a change of the driving route for vehicle 10 is needed (S55). For example, when it is determined that the manual zone is added or changed, route changer 45 determines whether the passenger can drive the manual zone added or changed corresponding to the driving information. When the degree of intervention needed in the manual zone added or changed satisfies the degree of positive manual intervention included in the driving information, that is, when the passenger can drive the manual zone added or changed, route changer 45 determines that the change of the driving route for vehicle 10 is unnecessary. When the degree of intervention needed in the manual zone added or changed does not satisfy the degree of positive manual intervention included in the driving information, that is, when the passenger cannot drive the manual zone added or changed, route changer 45 determines that the change of the driving route for vehicle 10 is needed.

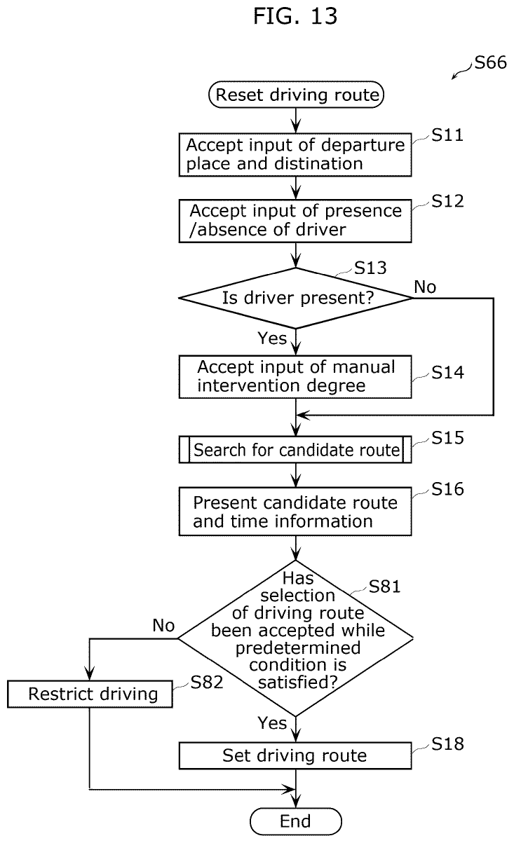

When the change of the driving route is needed (Yes in S55), route changer 45 resets the driving route (S56). Route changer 45 resets the driving route by performing the operation illustrated in FIG. 13 based on the updated route information. FIG. 13 is a flowchart illustrating one example of the operation to reset the driving route illustrated in FIG. 10 (S56). The operation illustrated in FIG. 13 includes the operation shown in FIG. 4 and steps S81 and S82, but not step S17. In FIG. 13, identical referential numerals are given to identical steps to those in FIG. 4, and the description thereof will be omitted or simplified.

As illustrated in FIG. 13, after controller 12 presents the candidate route and the time information to the passenger (S16), controller 12 determines whether the selection of the driving route is accepted while a predetermined condition is satisfied (S81). For example, the predetermined condition may be the time from presentation of the candidate route and the time information to the passenger to acceptance of the selection of the driving route, or may be that the current position of vehicle 10 currently driving does not reach a predetermined position. The predetermined position may be, for example, a position at which the driving route can be reset safely, and may be a position between the current position and the zone changed in the driving route, for example. Alternatively, the predetermined position may be a position from or through which the driving route does not reach the zone in which vehicle 10 cannot travel (e.g., the zone in which autonomous driving is not executable), and may be a position in the driving route in which vehicle 10 travels before reaching the zone, for example. As alternative examples, the predetermined condition may be both of the time from presentation of the candidate route and the time information to the passenger to acceptance of the selection of the driving route and that the current position of vehicle 10 currently driving does not reach the predetermined position, or may be another condition which can ensure safety for driving of vehicle 10.

When controller 12 accepts the selection of the driving route where the predetermined condition is satisfied, through acceptor 11 (Yes in S81), controller 12 transmits the information indicating the accepted driving route to server apparatus 20. After obtaining the information, route setter 44 then sets the driving route selected by the passenger to the driving route for vehicle 10 (S18). When controller 12 does not accept the selection of the driving route where the predetermined condition is satisfied, through acceptor 11 (No in S81), controller 12 outputs the information to server apparatus 20, the information indicating that the selection of the driving route where the predetermined condition is satisfied is not accepted. After obtaining the information, driving controller 66 then restricts driving of vehicle 10 (S82). Driving controller 66 may stop or decelerate vehicle 10. In this case, driving controller 66 transmits the control information to restrict driving of vehicle 10 through communicator 30 to vehicle 10.

Again with reference to FIG. 10, next, route changer 45 determines whether vehicle 10 has arrived at the destination (S57). For example, based on the driving information and the current position of vehicle 10, route changer 45 determines whether vehicle 10 has arrived at the destination. When route changer 45 determines that vehicle 10 has arrived at the destination (Yes in S57), route determiner 40 terminates the operation to reset the driving route. When route changer 45 determines that vehicle 10 has not arrived at the destination (No in S57), the processing returns to step S51 to continue the operation to reset the driving route. The operation illustrated in FIG. 10 is continuously performed while vehicle 10 is driving, for example. Thereby, route determiner 40 can reflect the road condition in the driving route in real time.

An example in which updater 41 determines that the manual zone is added or changed when a load of manual driving is increased has been described above, but not limited to this. Further, when a load of manual driving is decreased, updater 41 may also determine that the manual zone is added or changed. Examples of the case where a load of manual driving is decreased include those where traffic jams, traffic accidents, natural disasters, and traffic regulations are eliminated. In this case, updater 41 determines that autonomous driving is executable and monitoring by the driver is unnecessary, for example. Thereby, the driving route not extracted as a candidate route in the route setting before driving may be extracted as a candidate route as a result of a reduced degree of manual intervention needed. Resetting of such a candidate route as a driving route can reduce a load of driving on the driver or can shorten the time to be needed in some cases.

### Modification 1 of Embodiment 1

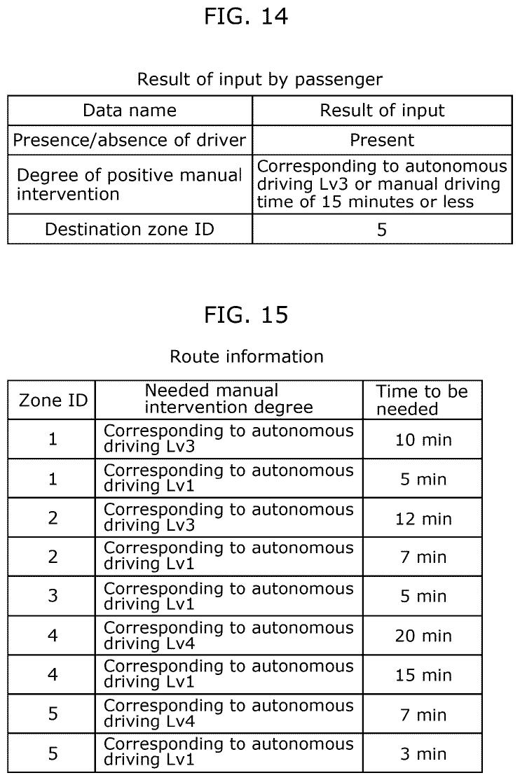

The information processing method according to the present modification will now be described with reference to FIGS. 14 to 18. Unlike the information processing method according to Embodiment 1, the information processing method according to the present modification also suggests a driving route when manual driving is performed in a zone where autonomous driving is executable. The configuration of the information processing system according to the present modification is identical to that of information processing system 1 according to Embodiment 1, and the description thereof will be omitted. Identical operations to those in Embodiment 1 will be described with reference to the drawings in Embodiment 1. FIG. 14 is a table showing one example of the result of input by the passenger according to the present modification. The result of input by the passenger shown in FIG. 14 is obtained by accepting an input in steps S11 to S14 shown in FIG. 4. The information indicating the result of input by the passenger shown in FIG. 14 is included in the driving information.

In the present modification, the degree of positive manual intervention in the result of input by the passenger includes the autonomous driving level and the manual driving time. The manual driving time indicates the time for which the driver is willing to drive, and is within 15 minutes in the example of FIG. 14.

The route information according to the present modification will be described with reference to FIG. 15. FIG. 15 is a table showing one example of the route information according to the present modification. In the example of FIG. 15, zone IDs “1”, “2”, “4”, and “5” represent zones in which autonomous driving is executable.

As shown in FIG. 15, the route information includes information indicating the intervention degree and time to be needed when manual driving is performed in a zone where autonomous driving is executable. For example, in an example in which zone ID is “1”, the degree of manual intervention needed when autonomous driving is performed in the zone corresponds to autonomous driving level 3, and the time to be needed is 10 minutes. When manual driving is performed in the zone with a degree of manual intervention corresponding to autonomous driving level 1, the time to be needed is 5 minutes. In the zone represented by zone ID “1”, the time to be needed can be shortened by manual driving rather than autonomous driving. Shortening of the time to be needed is one example of an improvement in driving of vehicle 10. Autonomous driving level 1 is one example of a driving operation which improves driving of vehicle 10. An improvement in driving is not limited to shortening of the time to be needed.

Although an example in which manual driving is performed at autonomous driving level 1 has been described in FIG. 15, the level may be autonomous driving level 2, or may include both of autonomous driving levels 1 and 2.

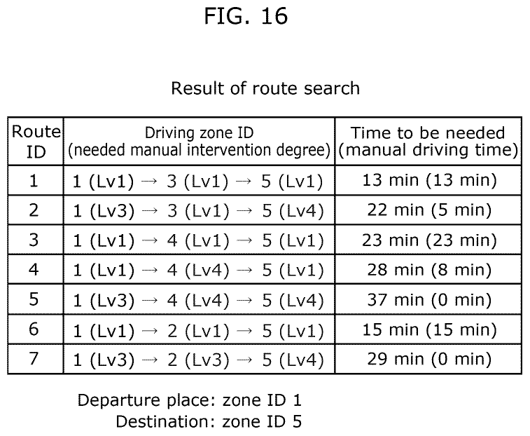

Next, the result of route search based on such a result of input by the passenger and such route information will be described with reference to FIG. 16. FIG. 16 is a table showing one example of the result of route search according to the present modification. The result of route search shown in FIG. 16 is obtained in step S22 illustrated in FIG. 5.

As shown in FIG. 16, the result of route search includes a route ID for identifying the searched route, a driving zone ID, and the time to be needed. The item within parentheses adjacent to the driving zone ID represents the degree of manual intervention needed, and is the autonomous driving level in the present modification. The item within parentheses adjacent to the time to be needed represents the manual driving time in the time to be needed. Comparing between route IDs “1” and “2”, the driving zone is the same while the degree of manual intervention needed and the time to be needed are different. Thus, in step S22, a plurality of identical driving routes having different degrees of manual intervention needed and different times to be needed is searched as temporary routes.

Next, processing to search for the candidate route according to the present modification will be described with reference to FIG. 5 in Embodiment 1.

In step S21 illustrated in FIG. 5, route searcher 42 obtains the result of input by the passenger transmitted by vehicle 10 (see FIG. 14, for example) through communicator 30. In step S22, route searcher 42 searches for the route to the destination (see FIG. 16, for example) based on the departure place, the destination, and the map information. Determiner 43 obtains the route information (see FIG. 15, for example) from storage 50.

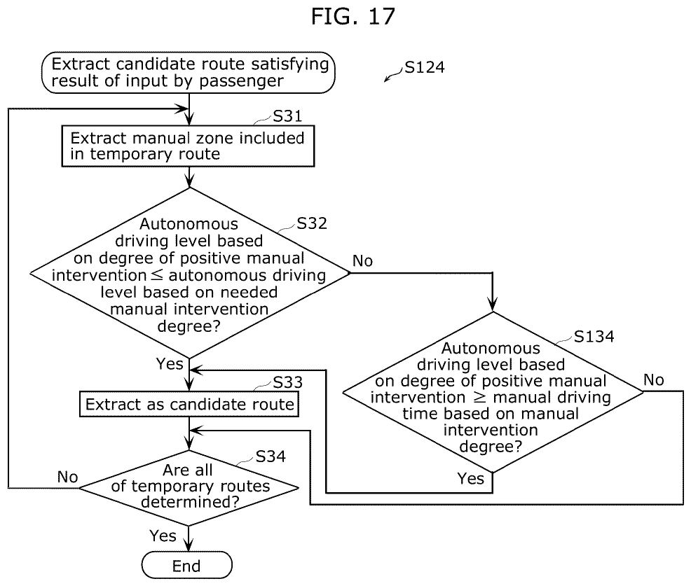

Determiner 43 performs the operation in step S124 illustrated in FIG. 17, rather than step S24 illustrated in FIG. 5. FIG. 17 is a flowchart illustrating one example of the operation to extract the candidate route according to the present modification. The flowchart illustrated in FIG. 17 is the flowchart illustrated in FIG. 7 further including determination in step S134.

As illustrated in FIG. 17, for the temporary route determined as No in step S32, determiner 43 determines whether the manual driving time based on the degree of manual intervention needed is within the manual driving time based on the degree of positive manual intervention (S134). Determiner 43 performs the above determination based on the manual driving time included in the result of route search and the manual driving time based on the degree of positive manual intervention, which may be included in the result of input by the passenger.

When the manual driving time included in the result of route search is equal to or less than the manual driving time based on the degree of positive manual intervention, which may be included in the result of input by the passenger (Yes in S134), determiner 43 goes to step S33. Yes in step S134 is one example of correspondence of the operation time in the driving operation which improves driving of vehicle 10 to the operation time included in the driving content. The zone determined as Yes in step S134 is one example of the zone where the operation time in the driving operation which improves driving of vehicle 10 corresponds to the operation time included in the driving content. The zone determined as Yes in step S134 is one example of the zone corresponding to the driving content acceptable to the driver.

When the manual driving time included in the result of route search is longer than the manual driving time based on the degree of positive manual intervention, which may be included in the result of input by the passenger (No in S134), determiner 43 goes to step S34.

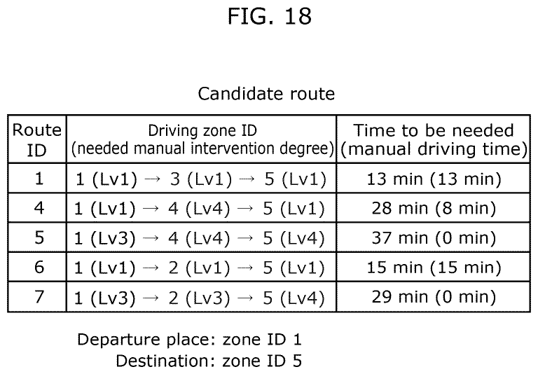

Thus, determiner 43 performs the determination in step S134 on all the temporary routes determined as No in step S32. In the present modification, route IDs “1” and “4” to “7” are set to the candidate routes as shown in FIG. 18. FIG. 18 is a table showing one example of the candidate route according to the present modification. Route IDs “1”, “4”, and “6” represent one examples of the first route while route IDs “1” and “6” represent routes including only the manual zone. Route IDs “5” and “7” are one examples of the second route.

As shown in routes ID “1” and “4” in FIG. 18, for example, determiner 43 can extract both of the first route and the second route as candidate routes in the same driving route. The passenger, who selects one of route IDs “1” and “4”, can select route ID “1” when he/she wants to reach the destination in a short time, and can select route ID “4” when he/she wants to reduce the manual driving time. The passenger, who selects one of route IDs “6” and “7”, can select autonomous driving or manual driving for all the zones in the same driving route.

As described above, in step S33, the temporary route determined as Yes in step S31 or S134 is extracted as a candidate route. The candidate route determined as Yes in step S134 can include a driving route in the case where manual driving is performed in a zone where autonomous driving is executable. Thereby, route determiner 40 can suggest the candidate route having an increased freedom of selection of the driving route by the passenger to the passenger.

### Modification 2 of Embodiment 1

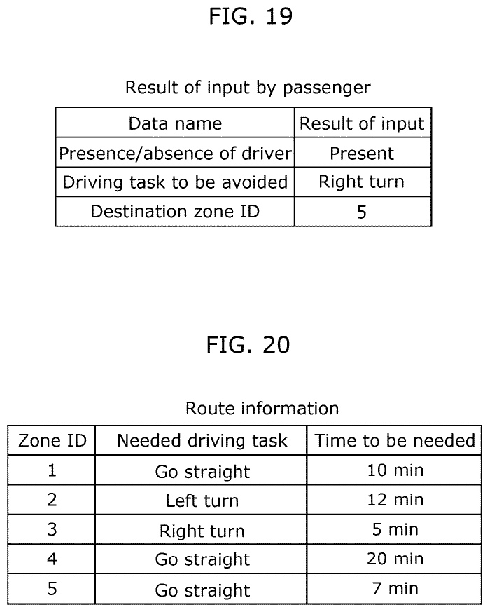

The information processing method according to the present modification will now be described with reference to FIGS. 19 to 22. Unlike the information processing method according to Embodiment 1, the information processing method according to the present modification obtains a driving task which the driver wants to avoid, and searches for the candidate route based on the task. The candidate route thus searched is a driving route in which the driver does not need to perform the operation which he/she wants to avoid. The configuration of the information processing system according to the present modification is identical to that of information processing system 1 according to Embodiment 1, and the description thereof will be omitted. Identical operations to those in Embodiment 1 will be described with reference to the drawings in Embodiment 1. FIG. 19 is a table showing one example of the result of input by the passenger according to the present modification. The result of input by the passenger shown in FIG. 19 is accepted through acceptance of the input in steps S11 to S14 shown in FIG. 4. The information indicating the result of input by the passenger shown in FIG. 19 is included in the driving information.

As show in in FIG. 19, the result of input by the passenger includes the presence/absence of the driver, the driving task to be avoided, and the destination zone ID. In the example of FIG. 19, “right turn” is input as a driving task to be avoided. “Right turn” is one example of the content of operation which enables specification of the driving operations acceptable to the driver. In this case, the driving operations acceptable to the driver are those excluding right turn. The driving task to be avoided is one example of the degree of positive manual intervention.

Although an example in which the result of input by the passenger includes the driving task to be avoided has been described above, the result of input by the passenger may include a driving task that the passenger wants to do (e.g., acceptable driving task), rather than the driving task to be avoided.

The route information according to the present modification will be described with reference to FIG. 20. FIG. 20 is a table showing one example of the route information according to the present modification.

As shown in FIG. 20, the route information includes the zone ID, the driving task needed to drive the zone, and the time to be needed in the zone. As one example, the driving task needed to drive the zone of zone ID “1” is to “go straight” and the time to be needed is 10 minutes. As another example, the driving task needed to drive the zone of zone ID “2” is “left turn” and the time to be needed is 12 minutes. The driving task needed for zone ID “2” may include “go straight”. The needed driving task is one example of the driving operation requested for driving of vehicle 10.

Next, the processing to search for the candidate route based on such a result of input by the passenger and such route information will be described with reference to FIG. 5 in Embodiment 1.

In step S21 illustrated in FIG. 5, route searcher 42 obtains the result of input by the passenger transmitted by vehicle 10 (see FIG. 19, for example) through communicator 30. In step S22, route searcher 42 searches for the route to the destination (see FIG. 6, for example) based on the departure place, the destination, and the map information. Determiner 43 obtains the route information (see FIG. 20, for example) from storage 50.

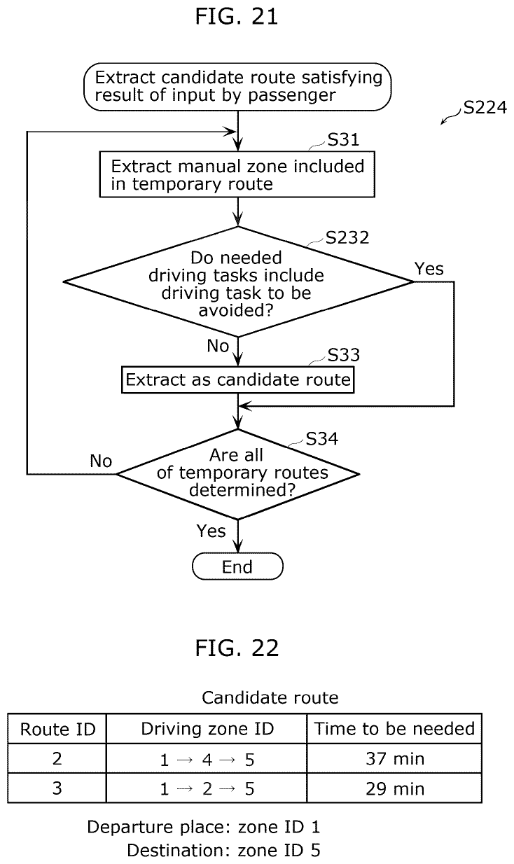

Determiner 43 then performs the operation in step S224 illustrated in FIG. 21 rather than step S24 illustrated in FIG. 5. FIG. 21 is a flowchart illustrating one example of the operation to extract the candidate route according to the present modification. The flowchart illustrated in FIG. 21 is the flowchart illustrated in FIG. 7 further including determination in step S232 instead of step S32.

As shown in FIG. 21, for the extracted manual zone, determiner 43 determines whether the driving task to be avoided by the driver is included in the needed driving task (S232). Determiner 43 performs the determination above based on the result of route search, the route information, and the result of input by the passenger. When the driving task to be avoided by the driver is not included in the needed driving tasks (No in S232), determiner 43 goes to step S33. No in step S232 is one example of correspondence of the driving operation requested for driving of vehicle 10 to the driving operation included in the driving content. The zone determined as No in step S232 is one example of the zone where the driving operation requested for driving of vehicle 10 corresponds to the driving operation included in the driving content. The zone determined as No in step S232 is one example of the zone corresponding to the driving content acceptable to the driver.

When the driving task to be avoided by the driver is included in the needed driving tasks (Yes in S232), determiner 43 goes to step S34.

Thus, determiner 43 performs the determination in step S232 on all the temporary routes. In the present modification, as shown in FIG. 22, routes represented by route IDs “2” and “3” which do not include “right turn” as the needed driving task are extracted as candidate routes. FIG. 22 is a table showing one example of the candidate route according to the present modification. The routes represented by route IDs “2” and “3” are one examples of the first route.

### Embodiment 2

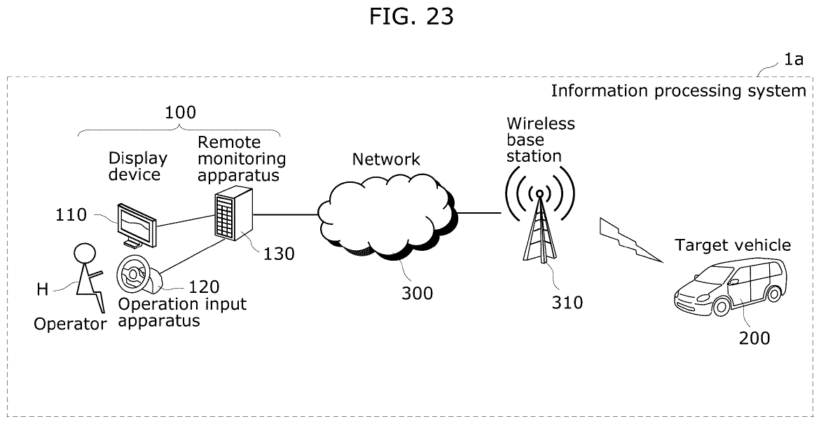

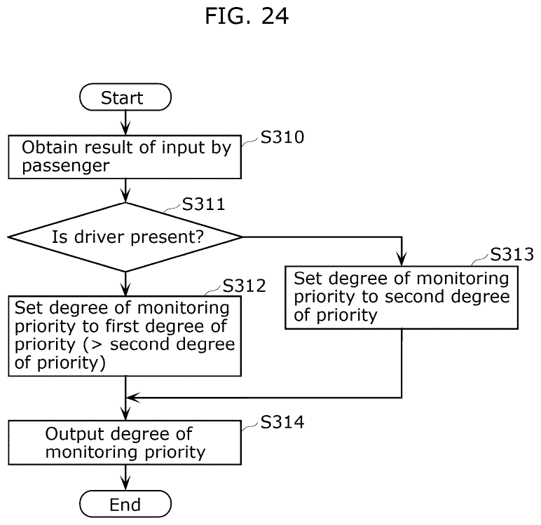

The information processing method according to the present embodiment will now be described with reference to FIGS. 23 and 24.

### [2-1. Configuration of Information Processing System]

Initially, the configuration of information processing system 1a according to the present embodiment will be described with reference to FIG. 23. FIG. 23 is a block diagram illustrating the functional configuration of information processing system 1a according to the present embodiment.

As illustrated in FIG. 23, information processing system 1a includes remote monitoring system 100, network 300, wireless base station 310, and target vehicle 200. Information processing system 1a communicably connects target vehicle 200 and remote monitoring system 100 (specifically, remote monitoring apparatus 130) through wireless base station 310 for a wireless LAN or a communication terminal and network 300. Wireless base station 310 and network 300 are one examples of the communication network. Target vehicle 200 is one example of a vehicle subjected to at least remote monitoring by operator H as a remote worker. Target vehicle 200 may be a vehicle subjected to remote monitoring and remote operation by operator H. Thus, the remote work includes at least one of remote monitoring or remote operation.

Remote monitoring system 100 is a system used by operator H in a remote place to monitor driving of target vehicle 200. In the present embodiment, an example in which remote monitoring system 100 can remotely operate target vehicle 200 has been described, but not limited to this. Remote monitoring system 100 includes display device 110, operation input apparatus 120, and remote monitoring apparatus 130.

Display device 110 is a monitor connected to remote monitoring apparatus 130 to display a video of target vehicle 200. Display device 110 displays a video captured by an image capturer included in target vehicle 200. Display device 110 may display the state of target vehicle 200 and those of obstacles around target vehicle 200 to operator H, thereby allowing operator H to recognize the states of target vehicle 200 and obstacles. The video includes a moving picture and a stationary picture. The obstacle indicates mainly a moving body which obstructs driving of target vehicle 200, such as a vehicle other than target vehicle 200 or a person. The obstacle may be real estate fixed to the ground.

Display device 110 may display the driving route set in target vehicle 200. Display device 110 may distinguish the autonomous zone and the manual zone in the driving route to display these, for example. Display device 110 is one example of a presentation apparatus. Display device 110 also functions as an outputter which outputs the driving route to operator H.

Operation input apparatus 120 is connected to remote monitoring apparatus 130 to receive a remote operation by operator H. Operation input apparatus 120 is an apparatus for operating target vehicle 200, such as a steering wheel and foot pedals (such as an accelerator pedal and a brake pedal). Operation input apparatus 120 outputs the input vehicle operation information to remote monitoring apparatus 130. Remote monitoring system 100, when not performing remote operation of target vehicle 200, may not include operation input apparatus 120 for remotely operating target vehicle 200.

Remote monitoring apparatus 130 is an apparatus used by operator H in a remote place to remotely monitor target vehicle 200 through a communication network. In the present embodiment, remote monitoring apparatus 130 is connected to operation input apparatus 120, and also functions as a remote operation apparatus for remotely operating target vehicle 200.

Remote monitoring apparatus 130 may have at least part of functions of server apparatus 20 in Embodiment 1. For example, remote monitoring apparatus 130 may have at least one of the functions of route determiner 40 and driving monitor 60. Alternatively, server apparatus 20 may be implemented with remote monitoring apparatus 130.

Target vehicle 200 is one example of a moving body which the passenger rides, and is subjected to at least remote monitoring by operator H. Target vehicle 200 is an autonomous vehicle switchable between autonomous driving and manual driving. In other words, target vehicle 200 has the autonomous driving mode and the manual driving mode. For example, target vehicle 200 may be vehicle 10 described in Embodiment 1.

It is suggested that one operator H monitors a plurality of target vehicles 200 in such remote monitoring system 100. In this case, to reduce the monitoring load on operator H, the followings are examined: A degree of monitoring priority indicating a degree of priority is set for each of target vehicles 200, and operator H performs monitoring based on the set degree of monitoring priority.

From the viewpoint of driving safety for a plurality of target vehicles 200, it is desired that the degree of monitoring priority be appropriately set. The degree of monitoring priority is set based on the vehicle information obtained from target vehicle 200, for example. The vehicle information includes the results of sensing from a variety of sensors included in target vehicle 200 (such as sensors which detect the position, the speed, the acceleration, the jerk (jolt), and the steering angle of target vehicle 200).

In the present embodiment, remote monitoring system 100 sets the degree of monitoring priority for target vehicle 200 based on the driving information concerning driving of target vehicle 200 by the driver. For example, remote monitoring system 100 may set the degree of monitoring priority for target vehicle 200 based on at least the driving skill. In other words, remote monitoring system 100 sets the degree of monitoring priority for target vehicle 200 based on at least the presence/absence of the driver. Alternatively, remote monitoring system 100 may set the degree of monitoring priority using the driving information in addition to the vehicle information, for example.

### [2-2. Operation of Information Processing System]

Subsequently, the operation of information processing system 1a will be described with reference to FIG. 24. FIG. 24 is a flowchart illustrating the operation to set the degree of monitoring priority in information processing system 1a according to the present embodiment. FIG. 24 mainly illustrates the operation in remote monitoring system 100. In the description below, it is assumed that a first degree of priority is higher than a second degree of priority as the degree of monitoring priority.

As illustrated in FIG. 24, remote monitoring apparatus 130 obtains the result of input by the passenger through a communication network from target vehicle 200 (S310). When a driver is present in target vehicle 200 (Yes in S311), remote monitoring apparatus 130 sets the degree of monitoring priority for target vehicle 200 to the first degree of priority (S312). When the driver is absent in target vehicle 200 (No in S311), remote monitoring apparatus 130 sets the degree of monitoring priority for target vehicle 200 to the second degree of priority (S313). Remote monitoring apparatus 130 sets a higher degree of monitoring priority for target vehicle 200 which the driver rides than that for target vehicle 200 which the driver does not ride.

Next, remote monitoring apparatus 130 outputs the set degree of monitoring priority (S314). For example, remote monitoring apparatus 130 displays the set degree of monitoring priority to operator H through display device 110. Remote monitoring apparatus 130 then may cause display device 110 to display the video concerning one or more target vehicles 200 selected by operator H, for example, based on the degree of monitoring priority. Alternatively, remote monitoring apparatus 130 may cause display device 110 to display the video concerning one or more target vehicles 200 having a higher degree of monitoring priority, based on the set degree of monitoring priority.

Thereby, information processing system 1a can reduce the monitoring load on operator H. In addition, operator H can effectively find occurrence of man-caused errors derived from driving by the driver.

In FIG. 24, an example in which remote monitoring apparatus 130 sets a higher degree of monitoring priority for target vehicle 200 which the driver rides has been described, but not limited to this. Remote monitoring apparatus 130 may set a higher degree of monitoring priority for target vehicle 200 which the driver does not ride.

In FIG. 24, the degree of monitoring priority is set according to the presence/absence of the driver. When the driver is present, the degree of monitoring priority may further be set according to the degree of positive manual intervention. For example, remote monitoring apparatus 130 may set a higher degree of monitoring priority as the degree of positive manual intervention is higher. The number of degrees of monitoring priority to be set may be 3 or more according to the driving information. A higher degree of positive manual intervention includes a lower autonomous driving level or a shorter manual driving time corresponding thereto.

Remote monitoring apparatus 130 may set a higher degree of monitoring priority for target vehicle 200 which the driver rides only for a period in which the driver is driving.

Remote monitoring apparatus 130 may set the degree of monitoring priority for target vehicle 200 by correcting a temporary degree of monitoring priority, which is set based on the vehicle information, based on the driving information. In this case, correction value of the temporary degree of monitoring priority is varied corresponding to the presence/absence of the driver.

### Embodiment 3

The information processing method according to the present embodiment will now be described. Unlike the information processing methods according to Embodiments 1 and 2, the driver is a remote worker in the information processing method according to the present embodiment. The configuration of the information processing system according to the present embodiment is identical to that of information processing system 1a according to Embodiment 2, and the description thereof will be omitted. Remote monitoring apparatus 130 included in information processing system 1a may be replaced by server apparatus 20 according to Embodiment 1. An example in which information processing system 1a includes server apparatus 20 instead of remote monitoring apparatus 130 will be described below, but not limited to this.

In the present embodiment, a passenger, who is the driver in Embodiments 1 and 2, can be replaced by a remote worker. For example, the remote worker performing a remote operation of target vehicle 200 is one example of performing manual driving.

Furthermore, server apparatus 20 obtains task information about the remote worker assigned to target vehicle 200. The task information is the information about the tasks assigned to the remote worker, such as remote monitoring or remote operation. For example, the information about the tasks is individual task information, such as the type of task, the time to be needed for the task, or the level of difficulty of the task. Alternatively, the task information may be total task information, such as the amount of tasks assigned, the amount of tasks to be assigned, and the schedule of tasks. The task information is stored in storage 50. The task information or the driving content may be accepted by acceptor 11.

Based on the task information, server apparatus 20 determines the driving content acceptable to the remote worker. Specifically, based on the task information obtained from storage 50, route determiner 40 determines the driving content executable by the remote worker. For example, the content of operation or the operation time is determined as the driving content corresponding to the type of task, the length of the time to be needed for the task, or the level of difficulty of the task (level of difficulty may be relative to the skill of the remote worker). For example, an easier operation is determined for a higher level of difficulty of the task. As an alternative example, the content of operation or the operation time may be determined as the driving content corresponding to the amount of task or emptiness in the task schedule. For example, an easier operation is determined as the task amount is larger. Thus, in the present embodiment, for example, the driving content with a heavier load is determined as the remote worker has a larger allowance, and the driving content with a lighter load is determined as the remote worker has a smaller allowance.

### OTHER EMBODIMENTS

The present disclosure have been described based on the embodiments and modifications (hereinafter, also referred to as embodiments and the like), these embodiments and the like should not be construed as limitations to the present disclosure. One or two or more aspects of the present disclosure may also cover a variety of modifications of the present embodiments and the like conceived and made by persons skilled in the art and embodiments including combinations of components in different embodiments and the like without departing from the gist of the present disclosure.

For example, the route determiner according to the embodiments and the like may obtain the driving acceptability of the passenger (driver) who can drive, and may search for the driving route also according to the obtained driving acceptability. The driving acceptability indicates the acceptability of the driver to a request for driving, and indicates whether the driver has a will to drive the vehicle, for example. The result of input by the passenger may include the result of input about the driving acceptability, for example, instead of or with the degree of positive manual intervention. For example, when there is no driving acceptability or the driver has no will to drive, the determiner may calculate only the second route of the first route and the second route even when the driver rides the vehicle. The driving acceptability is obtained through the acceptor before driving of the vehicle, for example.

In the information processing methods and the information processing systems according to the embodiments and the like, the route determiner may calculate the driving route according to the physical condition of the passenger who can drive. For example, the route determiner obtains the current physical condition of the driver input by the driver. The physical condition includes the health condition and the presence/absence or degree of drunkenness. The physical condition may be estimated from image analysis of a captured image of the face of the driver. Based on the result of input by the passenger and the physical condition of the driver, the determiner extracts the candidate route from the result of route search. For example, the determiner may correct the degree of positive manual intervention included in the result of input by the passenger based on the physical condition, and perform determination for extracting the candidate route, using the corrected degree of positive manual intervention. When the driver is in a bad physical condition, to reduce the driving load on the driver, the determiner corrects the degree of positive manual intervention included in the result of input by the passenger to raise the autonomous driving level thereof (e.g., autonomous driving level 2 is raised to autonomous driving level 3). The physical condition can be obtained at any timing, which may be before driving, during boarding, or during driving.

When a plurality of drivers is present in the vehicle, the display according to the embodiments and the like may present a display to promote driving by a driver in a good physical condition. Based on the physical condition of each driver obtained from the sensor, the controller may determine the driver who drives the manual zone in the driving route, and through the display, may perform notification of a driving request including the information indicating the determined driver.

When the passenger (driver) who has input the will to drive does not sit in the driver's seat, the display according to the embodiments and the like may perform a display for guiding the passenger to sit in the driver's seat. When the passenger (passenger other than the driver) who has input the will not to drive sits in the driver's seat, the display may perform a display for guiding the passenger to sit in a seat other than the driver's seat. Whether the passenger sitting in the driver's seat is the driver is determined based on the result of sensing by the sensor (e.g., a camera) in the vehicle and the information for identifying the passenger stored in the storage of the server apparatus, for example. The determination is performed through facial authentication, for example.

In the embodiments and the like, when the information processing system obtains reservation information when the vehicle is reserved, the reservation information including the driving information, that is, when the information processing system obtains the driving information before the passenger rides the vehicle, the display may perform a display for guiding the passenger (driver), who has input the will to drive, to sit in the driver's seat when the passenger (driver) rides the vehicle. Moreover, the display may perform a display for guiding the passenger to sit in a seat other than the driver's seat when the passenger (passenger other than the driver) who has input the will not to drive rides the vehicle.

The guiding of the passenger to sit in the driver's seat may be implemented by a presentation apparatus other than the display. For example, the presentation apparatus may be an apparatus which guides with at least one of a sound, light, or vibration. For example, the presentation apparatus may be an apparatus which guides with a combination of a display, a sound, light, and vibration.

An example in which the inputter and the display are mounted on the vehicle has been described in the embodiments and the like, but not limited to this. At least one of the inputter or the display may be included in the terminal apparatus which the passenger possesses. Any terminal apparatus can be used without limitation as long as it is communicably connected to the server apparatus. Examples thereof include portable terminal apparatuses such as smartphones and tablets. In this case, the result of input by the passenger may be included in the reservation information when the vehicle is reserved. In other words, the result of input by the passenger may be obtained before the passenger rides the vehicle. When the information processing system obtains the reservation information, the operation illustrated in FIG. 4 may be completed before the passenger rides the vehicle.

The embodiments and the like have been described assuming that the operation illustrated in FIG. 10 is performed during driving of the vehicle, but not limited to this. For example, when the information processing system obtains the reservation information, the operation illustrated in FIG. 10 may be performed during a period from the time when the reservation information is obtained to the time when the passenger rides the vehicle. In this case, the determinations in steps S55 and S57 may not be performed. The operation illustrated in FIG. 10 may be performed at least during driving of the vehicle.

Alternatively, all or part of the information processing systems according to the embodiments and the like may be implemented with a cloud server, or may be implemented as an edge apparatus mounted in the moving body. For example, at least part of the components included in the server apparatus according to the embodiments and the like may be implemented as part of the autonomous driving device to be mounted on the moving body. For example, at least one of the route determiner or the driving monitor may be implemented as part of the autonomous driving device to be mounted on the moving body.

The order of the processings described in embodiments and the like is one example. The order of the processings may be changed, or the processings may be executed concurrently. Part of the processings may not be executed.

At least part of the processings in the server apparatus described in the embodiments and the like may be executed in the vehicle. For example, the vehicle may obtain information needed for the processings, such as the route information, from the server apparatus, and may execute at least part of the processings in the server apparatus based on the obtained information. For example, the vehicle may execute at least one of the processing by the route determiner or that by the driving monitor.

The components described in the embodiments and the like may be implemented as software, or typically, may be implemented as LSI, which is an integrated circuit. These components may be individually formed into single chips, or may be formed into a single chip including part or all of the components. Although the LSI is used here, the integrated circuit may be referred to as IC, system LSI, super LSI, or ultra LSI depending on the integration density thereof. The integrated circuit can be formed by any method other than LSI, and may be implemented with a dedicated circuit or a general purpose processor. A field programmable gate array (FPGA) programmable after production of LSI or a reconfigurable processor having reconfigurable connection or setting of circuit cells inside the LSI after production of LSI may also be used. Furthermore, if an integrated circuit integration technique which will replace LSI appears due to progress or generation of another semiconductor technique, it is natural that the components may also be integrated using such a technique.

The division of functional blocks in the block diagrams is one example, and a plurality of functional blocks may be implemented as a single functional block, a single functional block may be divided into several blocks, or part of the functions may be transferred to another functional block. The functions of a plurality of functional blocks having similar functions may be processed by a single piece of hardware or software in a parallel or time-sharing manner.

The server apparatus included in the information processing system may be implemented with a single apparatus, or may be implemented with a plurality of apparatuses. For example, the processors in the server apparatus may be implemented with two or more server apparatuses. When the information processing system is implemented with a plurality of server apparatuses, the components included in the information processing system may be distributed to the plurality of server apparatuses in any manner. Any communication method can be used between the plurality of server apparatuses.

Furthermore, the technique according to the present disclosure may be the programs above, or may be a non-transitory computer-readable recording medium having the programs recorded thereon. Needless to say, the programs can be distributed through a transmission medium such as the Internet. For example, the programs and digital signals made of the programs may be transmitted through electric communication lines, wireless or wired communication lines, networks such as the Internet, and data broadcasting. Moreover, the programs and the digital signals made of the programs may be executed by other independent computer systems by recording these on recording media and transporting the recording media or by transporting these through the network.

In the embodiments, the components may be configured with dedicated hardware, or may be implemented by executing software programs suitable for the components. Alternatively, the components may be implemented by a program executor such as a CPU or a processor which reads out and executes software programs recorded on a recording medium such as a hard disk or a semiconductor memory.

### INDUSTRIAL APPLICABILITY

The present disclosure can be widely used in systems for operating moving bodies switchable between autonomous driving and manual driving.

1. An information processing method to be executed by a computer, the information processing method comprising:
obtaining first information indicating a departure place and a destination of a moving body switchable between autonomous driving and manual driving;
obtaining second information indicating an autonomous driving level 2 or an autonomous driving level 3;
calculating a travel route based on the first information and the second information, the travel route including a manual zone where an operator of the moving body is requested to drive and an autonomous zone where the operator is not requested to drive;
causing the moving body to perform the autonomous driving based on the travel route calculated; and
presenting an alert which notifies the operator of switching between the manual driving and the autonomous driving.

2. The information processing method according to claim 1,
wherein the calculating of the travel route includes:
searching for a travel route based on the first information and the map information; and
extracting the travel route satisfying the second information from the result of route search.

3. The information processing method according to claim 1,
wherein the second information includes a driving skill indicating whether the operator can drive the moving body.

4. The information processing method according to claim 2,
wherein the calculating of the travel route includes:
calculating only the second route when the driving skill indicates that driving is not executable; and
calculating at least one of the first route or the second route when the driving skill indicates that driving is executable.

5. The information processing method according to claim 1,
wherein the second information includes a driving content acceptable to the operator.

6. The information processing method according to claim 5,
wherein the calculating of the travel route includes:
calculating a temporary route according to the departure place and the destination;
extracting a manual zone included in the temporary route;
determining whether the manual zone extracted is a zone corresponding to the driving content; and
calculating the temporary route as the first route when it is determined that the manual zone extracted is the zone corresponding to the driving content.

7. The information processing method according to claim 6,
wherein the driving content includes a driving operation acceptable to the operator, and
the zone corresponding to the driving content includes a zone in which a driving operation requested for travel of the moving body corresponds to the driving operation included in the driving content.

8. The information processing method according to claim 6,
wherein the driving content includes the driving operation acceptable to the operator, and the zone corresponding to the driving content includes a zone in which a driving operation to improve travel of the moving body corresponds to the driving operation included in the driving content.

9. The information processing method according to claim 5, further comprising:
obtaining task information of a remote worker of the moving body included in the operator; and
determining the driving content acceptable to the remote worker, based on the task information.

10. The information processing method according to claim 1, further comprising:
notifying the operator who can drive the moving body of a driving request through a presentation apparatus when the moving body reaches the manual zone in the first route output or a place that is a predetermined distance to the manual zone.

11. The information processing method according to claim 1, further comprising:
determining whether the operator who can drive is driving the moving body in the manual zone in the first route output.

12. The information processing method according to claim 5,
wherein the driving content includes a driving operation executable by the operator, the information processing method further comprises determining whether the operator who can drive is driving the moving body in the manual zone in the first route output, and
the determining whether the operator is driving further includes determining whether the driving operation included in the driving content is being performed.

13. The information processing method according to claim 11, further comprising:
outputting an instruction to restrict travel of the moving body when it is determined that the operator who can drive is not driving the moving body in the manual zone in the first route.

14. The information processing method according to claim 11, further comprising:
setting a degree of monitoring priority for the moving body corresponding to the second information; and
outputting the degree of monitoring priority which is set.

15. The information processing method according to claim 1, further comprising:
obtaining traffic situation information;
determining whether a traffic situation in the travel route has changed after the outputting of the travel route, based on the traffic situation information;
determining whether the manual zone is added or changed in the travel route due to the change of the traffic situation, when it is determined that the traffic situation has changed;
determining whether the operator can drive the manual zone added or changed according to the second information, when it is determined that the manual zone is added or changed; and
changing the travel route when it is determined that the operator cannot drive.

16. The information processing method according to claim 1,
wherein the calculating of the travel route includes calculating a plurality of travel routes, and the outputting of the travel route includes presenting the plurality of travel routes as candidate routes through the presentation apparatus.

17. The information processing method according to claim 5,
wherein an interface for accepting an input of the driving content is presented through a presentation apparatus.

18. The information processing method according to claim 1, wherein
the alert is presented while the moving body is traveling.

19. The information processing method according to claim 1, wherein
the alert is presented to a driver of the moving body.

20. The information processing method according to claim 1, wherein
the alert is presented by a sound.

21. An information processing system, comprising:
a first obtainer which obtains first information indicating a departure place and a destination of a moving body switchable between autonomous driving and manual driving;
a second obtainer which obtains second information defined as an autonomous driving level 2 or an autonomous driving level 3;
a calculator which calculates a travel route based on the first information and the second information, the travel route has 2 or more zones which include a manual zone where the operator is requested to drive and autonomous zone; and
causing the moving body to perform the autonomous driving including an operation based on the travel route by outputting the travel route calculated and the driving operation needed in the manual zone.

22. An information processing system, comprising:
a processor; and
memory,
wherein, using the memory, the processor:
obtains first information indicating a departure place and a destination of a moving body switchable between autonomous driving and manual driving;
obtains second information defined as an autonomous driving level 2 or an autonomous driving level 3;
calculates a travel route based on the first information and the second information, the travel route has 2 or more zones which include a manual zone where the operator is requested to drive and autonomous zone; and
causes the moving body to perform the autonomous driving including an operation based on the travel route by outputting outputs the travel route calculated and the driving operation needed in the manual zone.
